(19) United States
(12) Patent Application Publication
(10) Pub. No.: US 2012/0104931 A1
(43) Pub. Date: May 3, 2012

(54) PLASMA DISPLAY PANEL

(76) Inventors: Kaname Mizokami, Kyoto (JP); Shinsuke Yoshida, Osaka (JP); Shozo Oshio, Osaka (JP); Kazuhiko Sugimoto, Osaka (JP); Nobumitsu Aibara, Osaka (JP); Yoshihisa Nagasaki, Osaka (JP); Yukihiko Sugio, Osaka (JP); Masaaki Akamatsu, Osaka (JP)

(21) Appl. No.: 13/202,182

(22) PCT Filed: Mar. 11, 2011
(86) PCT No.: PCT/JP2011/001428

§ 371 Date: Aug. 18, 2011

(30) Foreign Application Priority Data
Mar. 18, 2010 (JP) 2010-062368

(51) Int. Cl. H01J 1/62; H01J 1/70

(52) U.S. Cl. 313/486

(57) ABSTRACT

A protective layer of a plasma display panel includes a base layer formed on a dielectric layer, and a plurality of aggregated particles dispersed on an entire surface of the base layer. Phosphor layers include a green phosphor layer containing an Mn²⁺ activated short persistent green phosphor whose 1/10 afterglow time exceeds 2 msec and stays below 5 msec, and a Ce³⁺ activated green phosphor or an Eu²⁺ activated green phosphor having a luminescence peak in a wavelength region of at least 490 nm to less than 560 nm.

### TECHNICAL FIELD

The technology disclosed herein relates to a plasma display panel used in, for example, a display device.

### BACKGROUND ART

A plasma display panel (hereinafter, called PDP) has a front plate and a rear plate. The front plate includes a glass substrate, display electrodes formed on a main surface of the glass substrate, a dielectric layer covering the display electrodes to function as a capacitor, and a protective layer made of magnesium oxide (MgO) and formed on the dielectric layer. Meanwhile, the rear plate includes a glass substrate, data electrodes formed on a main surface of the glass substrate, an insulating layer covering the data electrodes, barrier ribs formed on the insulating layer, and phosphor layers respectively formed between the barrier ribs to emit red, green, and blue light.

The front plate and the rear plate are air-tightly sealed to each other with their electrode-formed surfaces facing each other. A discharge gas containing neon (Ne) and xenon (Xe) is enclosed in a discharge space divided by the barrier ribs. The discharge gas is electrically discharged by a video signal voltage selectively applied to the display electrodes. The electric discharge generates ultraviolet light, and the generated ultraviolet light excites the phosphor layers. The excited phosphor layers respectively emit the red, green, and blue light. This is the mechanism of a color image display in the PDP (refer to Patent Document 1).

### PRIOR ART DOCUMENT

### Patent Document

[Patent Document 1] Unexamined Japanese Patent Publication No. 2003-128430

### SUMMARY OF INVENTION

A first disclosed PDP has a front plate and a rear plate disposed so as to face the front plate. The front plate includes display electrodes, a dielectric layer covering the display electrodes, and a protective layer formed to coat the dielectric layer. The protective layer includes a base layer formed on the dielectric layer, and a plurality of aggregated particles dispersed on an entire surface of the base layer. Each of the aggregated particles includes a plurality of crystal particles made of metallic oxide and aggregating to one another. The rear plate has phosphor layers excited by ultraviolet light. The phosphor layers include a green phosphor layer containing an Mn²⁺ activated short persistent green phosphor whose 1/10 afterglow time exceeds 2 msec and stays below 5 msec, and a Ce³⁺ activated green phosphor or an Eu²⁺ activated green phosphor having a luminescence peak in a wavelength region of at least 490 nm to less than 560 nm.

A second disclosed PDP has a front plate and a rear plate disposed so as to face the front plate. The front plate includes display electrodes, a dielectric layer covering the display electrodes, and a protective layer formed to coat the dielectric layer. The protective layer includes a base layer formed on the dielectric layer, a plurality of first particles dispersed on an entire surface of the base layer, and a plurality of second particles dispersed on the entire surface of the base layer. Each of the first particles includes a plurality of crystal particles made of metallic oxide and aggregating to one another, and each of the second particles is a crystal particle having a cubic shape. The rear plate has phosphor layers excited by ultraviolet light. The phosphor layers include a green phosphor layer containing an Mn²⁺ activated short persistent green phosphor whose 1/10 afterglow time exceeds 2 msec and stays below 5 msec, and a Ce³⁺ activated green phosphor or an Eu²⁺ activated green phosphor having a luminescence peak in a wavelength region of at least 490 nm to less than 560 nm.

### BRIEF DESCRIPTION OF THE DRAWINGS

FIG. 1 is a perspective view illustrating a PDP structure.

FIG. 2 is an electrode arrangement view of the PDP.

FIG. 3 is a block circuit diagram of a plasma display device.

FIG. 4 is a waveform chart of drive voltages in the plasma display device according to an embodiment.

FIG. 5 is a schematic chart illustrating a sub field structure in the plasma display device according to the embodiment.

FIG. 6 is an illustration of coding in the plasma display device according to the embodiment.

FIG. 7 is a sectional view schematically illustrating a structure of a front plate according to the embodiment.

FIG. 8 is an enlarged view of a part where a protective layer is formed according to the embodiment.

FIG. 9 is an enlarged view of a surface of the protective layer according to the embodiment.

FIG. 10 is an enlarged view of an aggregated particle according to the embodiment.

FIG. 11 is a graph illustrating a cathode luminescence spectrum of crystal particles according to the embodiment.

FIG. 12 is a graph illustrating a relationship between an electron releasability and a Vscn lighting voltage.

FIG. 13 is a graph illustrating a relationship between the electron releasability and a lighting time of the PDP.

FIG. 14 is an enlarged view for describing a coating ratio.

FIG. 15 is a characteristic chart in which sustain discharge voltages are compared.

FIG. 16 is a characteristic chart illustrating a relationship between the electron releasability and an average particle diameter of aggregated particles.

FIG. 17 is a characteristic chart illustrating a relationship between a rate of occurrence of barrier rib breakage and an average particle diameter of crystal particles.

FIG. 18 is a process chart illustrating steps for formation of a protective layer according to the embodiment.

FIG. 19 is a graph illustrating a relationship between a degree of luminance and an afterglow time in a ZSM phosphor depending on an Mn activation amount.

FIG. 20 is a graph illustrating afterglow characteristics of green luminescence in the PDP.

FIG. 21 is a graph illustrating a relationship between the PDP lighting time and a green luminance maintenance factor.

FIG. 22 is a graph illustrating CIE chromaticity coordinates in green phosphor powder in which a ZSM phosphor whose Mn activation amount is 8 atom % is mixed with a YAG phosphor.

FIG. 23 is a graph illustrating a relationship between a luminescence spectrum and a mixture ratio of the YAG phosphor in the ZSM phosphor.

FIG. 24 is a graph illustrating a relationship between the degree of luminance and the mixture ratio of the YAG phosphor in the ZSM phosphor.

FIG. 25 is a graph illustrating afterglow characteristics in the PDP to which the green phosphor according to the embodiment is applied.

FIG. 26 is a graph illustrating luminescence spectrums of Eu³⁺-activated red phosphor powders respectively having different luminescent colors.

FIG. 27 is a graph illustrating afterglow characteristics in a red phosphor powder according to the embodiment.

FIG. 28 is a chart illustrating luminescence spectrums depending on a proportion of P in YPV phosphor powder.

FIG. 29 is a graph illustrating afterglow characteristics in the YPV phosphor powder.

FIG. 30 is a graph illustrating a relationship between the afterglow time and a degree of intensity of orange light relative to red light in the YPV phosphor powder.

FIG. 31 is a graph illustrating a relationship among the proportion of P in the YPV phosphor powder, a total number of photons evaluated under the excitation by vacuum ultraviolet light (147 nm), and a luminance relative value.

FIG. 32 is a graph illustrating an example of afterglow characteristics of red, green, and blue light in the PDP according to the embodiment.

### DESCRIPTION OF EMBODIMENTS

1. Structure of PDP 1

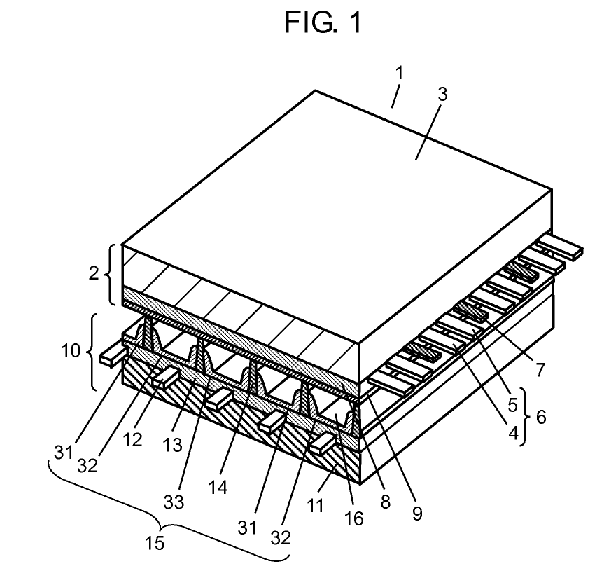

A basic structure of a PDP corresponds to that of a general alternating current (AC) surface discharge PDP. As illustrated in FIG. 1, PDP 1 has a structure where front plate 2 including, for example, front glass substrate 3 and rear plate 10 including, for example, rear glass substrate 11 are disposed facing each other. Outer peripheral portions of front plate 2 and rear plate 10 are air-tightly sealed to each other with a sealing member made of, for example, glass frit. A discharge gas containing, for example, neon (Ne) and xenon (Xe) is enclosed in discharge space 16 in PDP 1 formed by the sealed plates under a pressure in the range of 53 kPa (400 Torr) to 80 kPa (600 Torr).

A plurality of pairs of band-shape display electrodes 6 each including scan electrode 4 and sustain electrode 5 and a plurality of black stripes 7 are provided on front glass substrate 3 in parallel with each other. Dielectric layer 8 functioning as a capacitor is formed on front glass substrate 3 so as to cover display electrodes 6 and black stripes 7. A surface of dielectric layer 8 is coated with protective layer 9 made of, for example, magnesium oxide (MgO).

Scan electrodes 4 and sustain electrodes 5 are transparent electrodes made of an electrically conductive metallic oxide such as indium tin oxide (ITO), tin dioxide (SnO₂), or zinc oxide (ZnO) on which bus electrodes containing Ag are formed.

A plurality of data electrodes 12 made of an electrically conductive material containing silver (Ag) as its main component is formed on rear glass substrate 11 in parallel with each other in a direction orthogonal to display electrodes 6. Data electrodes 12 are coated with insulating layer 13. Barrier ribs 14 are formed on insulating layer 13 between data electrodes 12 to a predetermined height large enough to divide discharge space 16. Red phosphor layer 31 which emits red light, green phosphor layer 32 which emits green light, and blue phosphor layer 33 which emits blue light under ultraviolet light are sequentially formed by a coating technique in grooves between barrier ribs 14 for each of data electrodes 12. Hereinafter, red phosphor layer 31, green phosphor layer 32, and blue phosphor layer 33 may be collectively called phosphor layers 15. A discharge cell is formed at a position where display electrode 6 and data electrode 12 intersect with each other. The discharge cells respectively having phosphor layers 15 arranged in the direction of display electrodes 6 constitute color display pixels.

In the present embodiment, the discharge gas enclosed in discharge space 16 includes Xe by at least 10 vol. % to at most 30 vol. %.

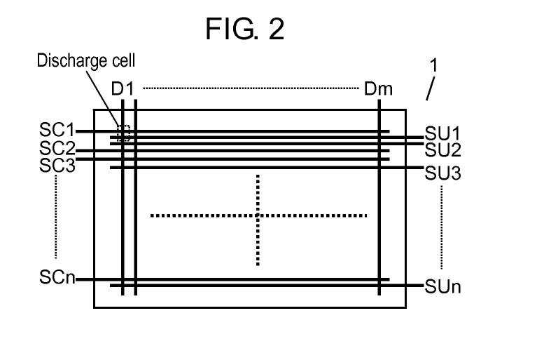

As illustrated in FIG. 2, PDP 1 has n number of scan electrodes SC1 to SCn arranged so as to extend in a long-side direction, and n number of sustain electrodes SU1 to SUn arranged so as to extend in the long-side direction. Further, PDP 1 has m number of data electrodes D1 to Dm arranged so as to extend in a short-side direction. A discharge cell is formed at a part in which scan electrode SC1 and sustain electrode SU1 intersect with data electrode D1, and there are m×n discharge cells in the discharge space. A region where the discharge cells are formed is an image display region. The sustain electrodes and the scan electrodes are connected to connection terminals provided in a marginal portion of the front plate on the outer side of the image display region. The data electrodes are connected to connection terminals provided in a marginal portion of the rear plate on the outer side of the image display region.

2. Structure of Plasma Display Device 100

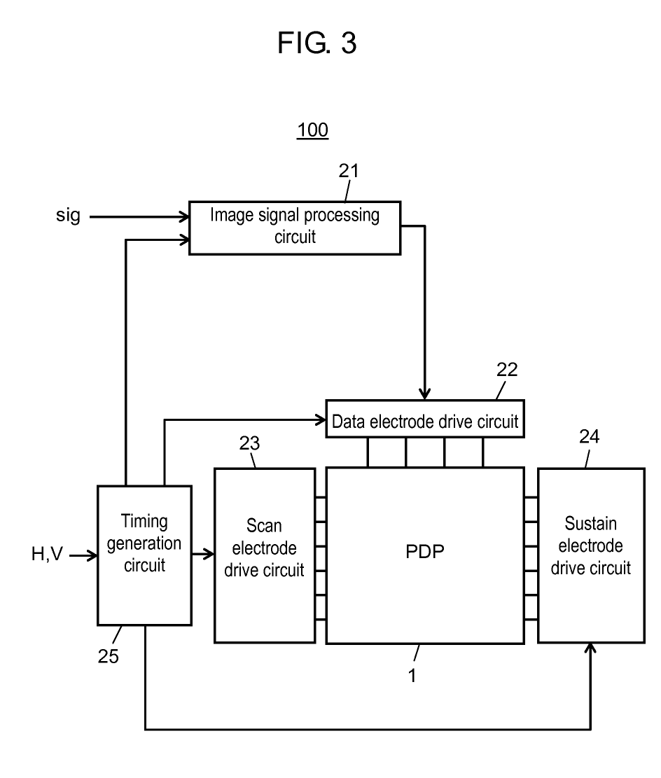

As illustrated in FIG. 3, plasma display device 100 has PDP 1, image signal processing circuit 21, data electrode drive circuit 22, scan electrode drive circuit 23, sustain electrode drive circuit 24, timing generation circuit 25, and a power supply circuit (not illustrated in the drawings).

Image signal processing circuit 21 inputs an image signal for right eye and an image signal for left eye alternately per field. Image signal processing circuit 21 converts the inputted image signal for right eye into an image data for right eye indicating luminescence or non-luminescence per sub field. Further, image signal processing circuit 21 converts the inputted image signal for left eye into an image data for left eye indicating luminescence or non-luminescence per sub field. Data electrode drive circuit 22 converts the image data for right eye and the image data for left eye into address pulses respectively for data electrodes D1 to Dm. Data electrode drive circuit 22 applies an address pulse to each of data electrodes D1 to Dm.

Timing generation circuit 25 generates various timing signals based on horizontal synchronous signal H and vertical synchronous signal V, and supplies the generated timing signals to the respective drive circuit blocks. Further, timing generation circuit 25 outputs timing signals to open and close shutters of shutter glasses to a timing signal output unit. The timing signal output unit (not illustrated in the drawings) converts the timing signal into, for example, an infrared signal using a light emitting device such as an LED, and supplies the resulting signal to the shutter glasses (not illustrated in the drawings). Scan electrode drive circuit 23 supplies a drive voltage waveform to each of the scan electrodes based on the timing signals. Sustain electrode drive circuit 24 supplies a drive voltage waveform to each of the sustain electrodes based on the timing signals. The shutter glasses (not illustrated in the drawings) have a receiver which receives the timing signals outputted from the timing signal output unit (not illustrated in the drawings), a liquid crystal shutter R for right eye, and a liquid crystal shutter L for left eye. The shutter glasses (not illustrated in the drawings) open and close the liquid crystal shutter R for right eye and the liquid crystal shutter L for left eye based on the timing signals.

3. Method for Driving PDP 1

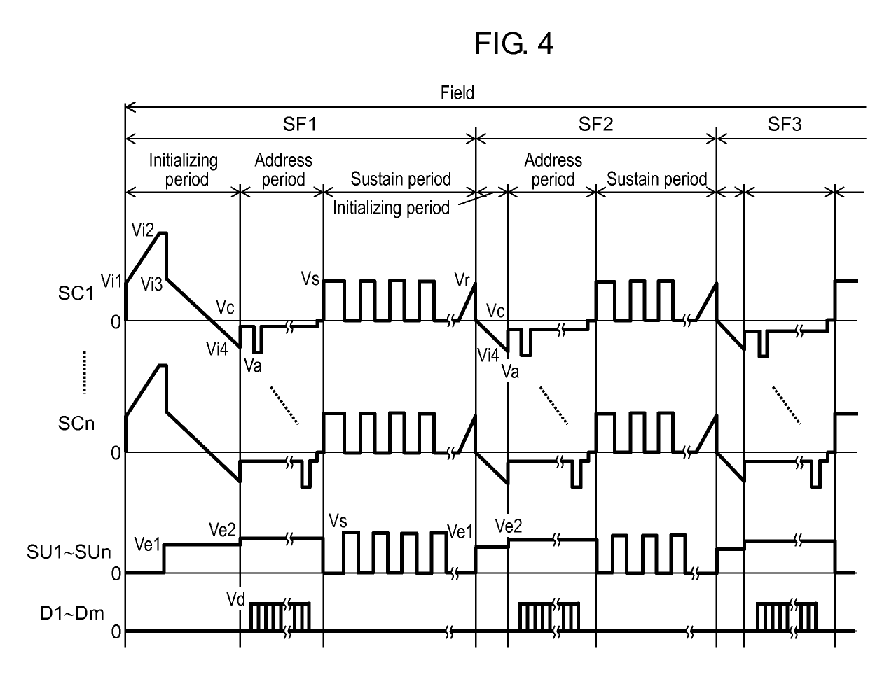

As illustrated in FIG. 4, PDP 1 according to the present embodiment is driven by a sub field driving method. According to the sub field driving method, one field includes a plurality of sub fields. Each sub field has an initializing period, an address period, and a sustain period. The initializing period is a period for generating initializing discharge in the discharge cells. The address period, which follows the initializing period, is a period for generating address discharge to select the discharge cell to become luminescent. The sustain period is a period for making the discharge cell selected in the address period generate sustain discharge.

3-1-1. Initializing Period

During the initializing period of a first sub field, data electrodes D1 to Dm and sustain electrodes SU1 to SUn are kept at 0 (V). A ramp voltage gradually rising from voltage Vi1 (V) equal to or below a discharge start voltage to voltage Vi2 (V) exceeding the discharge start voltage is applied to scan electrodes SC1 to SCn. Then, a first round of very weak initializing discharge is generated in all of the discharge cells. As a result of the initializing discharge, negative wall voltages are stored on scan electrodes SC1 to SCn, and positive wall voltages are stored on sustain electrodes SU1 to SUn and data electrodes D1 to Dm. The wall voltage is a voltage generated by wall charges stored on, for example, protective layer 9 and phosphor layers 15.

After that, sustain electrodes SU1 to SUn are kept at positive voltage Ve1 (V). A ramp voltage gradually falling from voltage Vi3 (V) to voltage Vi4 (V) is applied to scan electrodes SC1 to SCn. Then, a second round of very weak initializing discharge is generated in all of the discharge cells, and wall voltages between scan electrodes SC1 to SCn and sustain electrodes SU1 to SUn are thereby weakened. The wall voltages on data electrodes D1 to Dm are adjusted to values suitable for an address operation. Thus, a forced initializing operation is completed in which the initializing discharge is forcibly performed to all of the discharge cells.

3-1-2. Address Period

During the address period subsequent to the initializing period, voltage Ve2 is applied to sustain electrodes SU1 to SUn, and voltage Vc is applied to scan electrodes SC1 to SCn. Then, negative scan pulse voltage Va (V) is applied to scan electrode SC1, and positive address pulse voltage Vd (V) is then applied to data electrode Dk (k=1 to m) of the discharge cell to be displayed on the first row among data electrodes D1 to Dm. A voltage at the intersection of data electrode Dk with scan electrode SC1 then results in a value obtained by adding the wall voltage on data electrode Dk and the wall voltage on scan electrode SC1 to an externally applied voltage (Vd to Va) (V), meaning that the voltage at the intersection of data electrode Dk with scan electrode SC1 exceeds the discharge start voltage. Then, the address discharge is generated between data electrode Dk and scan electrode SC1 and also between sustain electrode SU1 and scan electrode SC1. Then, a positive wall voltage is stored on scan electrode SC1 of the discharge cell where the address discharge was generated, a negative wall voltage is stored on sustain electrode SU1 of the discharge cell where the address discharge was generated, and a negative wall voltage is stored on data electrode Dk of the discharge cell where the address discharge was generated.

On the other hand, the voltages at the intersections of data electrodes D1 to Dm with scan electrode SC1, to which address pulse voltage Vd (V) was not applied, stay below the discharge start voltage. Therefore, the address discharge is not generated in the relevant discharge cells. The address operation described so far is performed to all of the discharge cells up to an nth row. The address period ends when the address operation in the discharge cell on the nth row is completed.

3-1-3. Sustain Period

During the sustain period subsequent to the address period, positive sustain pulse voltage Vs (V) is applied as a first voltage to scan electrodes SC1 to SCn, and a ground potential, that is 0 (V), is applied as a second voltage to sustain electrodes SU1 to SUn. In the discharge cell where the address discharge is generated, a voltage between scan electrode SCi and sustain electrode SUi results in a value obtained by adding the wall voltage on scan electrode SCi and the wall voltage on sustain electrode SUi to sustain pulse voltage Vs (V), which exceeds the discharge start voltage. Then, the sustain discharge is generated between scan electrode SCi and sustain electrode SUi. The sustain discharge generates ultraviolet light, and the generated ultraviolet light excites the phosphor layers, making them emit the light. A negative wall voltage is stored on scan electrode SCi, a positive wall voltage is stored on sustain electrode SUi, and a positive wall voltage is stored on data electrode Dk.

There is no sustain discharge in any of the discharge cells where the address discharge was not generated during the address period. Therefore, the wall voltages when the initializing period ends are retained. Then, the second voltage, that is 0 (V), is applied to scan electrodes SC1 to SCn. The first voltage, that is sustain pulse voltage Vs (V), is applied to sustain electrodes SU1 to SUn. In the discharge cell where the sustain discharge was generated, a voltage between sustain electrode SUi and scan electrode SCi exceeds the discharge start voltage, and the sustain discharge is generated again between sustain electrode SUi and scan electrode SCi. Therefore, a negative wall voltage is stored on sustain electrode SUi, and a positive wall voltage is stored on scan electrode SCi.

Similarly, such a number of sustain pulse voltages Vs (V) that are responsive to luminance weights are thus applied to scan electrodes SC1 to SCn and sustain electrodes SU1 to SUn in turn, so that the sustain discharge is continuously generated in the discharge cells where the address discharge was generated during the address period. When the application of a predetermined number of sustain pulse voltages Vs (V) is completed, the sustain operation during the sustain period ends. In a last stage of the sustain period, a ramp waveform voltage gradually rising toward voltage Vr is applied to scan electrodes SC1 to SCn. With the positive wall voltage sill left on data electrode Dk, the wall voltages on scan electrode SCi and sustain electrode SUi are weakened. Then, the sustain operation during the sustain period ends.

3-1-4. Second Sub Field and Fields Thereafter

During the initializing period in SF2 in which a selective initializing operation is performed, voltage Ve1 is applied to sustain electrodes SU1 to SUn, and voltage 0 (V) is applied to data electrodes D1 to Dm. A ramp waveform voltage gradually falling toward voltage Vi4 is applied to scan electrodes SC1 to SCn. Then, a weak initializing discharge is generated in the discharge cells where the sustain discharge was generated in immediately preceding sub field SF1, and the wall voltages on scan electrode SCi and sustain electrode SUi are thereby weakened. Regarding data electrode Dk, the positive wall voltage is adequately stored on data electrode Dk by the most recent sustain discharge. The wall voltage overly stored is discharged to be adjusted to a wall voltage suitable for the address operation. There is no discharge in the discharge cells where the sustain discharge was not generated in the immediately preceding sub field, and the wall voltage obtained when the initializing period in the immediately preceding sub field ended is retained. In the selective initializing operation, the initializing discharge is selectively performed to the discharge cells subjected to the address operation during the address period in the immediately preceding sub field, in other words, the discharge cells subjected to the sustain operation during the sustain period.

An operation during the address period that follows is similar to the operation during the address period of SF1, which will not be described in detail. An operation during the sustain period that follows is similar to the operation during the sustain period in SF1 except for the number of sustain pulses. Operations during SF3 to SF5 that follow are similar to the operation during SF2 except for the number of sustain pulses.

Examples of the voltage value applied to the respective electrodes in the present embodiment are; voltage Vi1=145 (V), voltage Vi2=335 (V), voltage Vi3=190 (V), voltage Vi4=−160 (V), voltage Va=−180 (V), voltage Vc=−35 (V), voltage Vs=190 (V), voltage Vr=190 (V), voltage Ve1=125 (V), voltage Ve2=130 (V), and voltage Vd=60 (V). These voltage values can be suitably set to optimal values depending on the characteristics of PDP 1 and specification of plasma display device 100.

3-1-5. Sub Field Structure

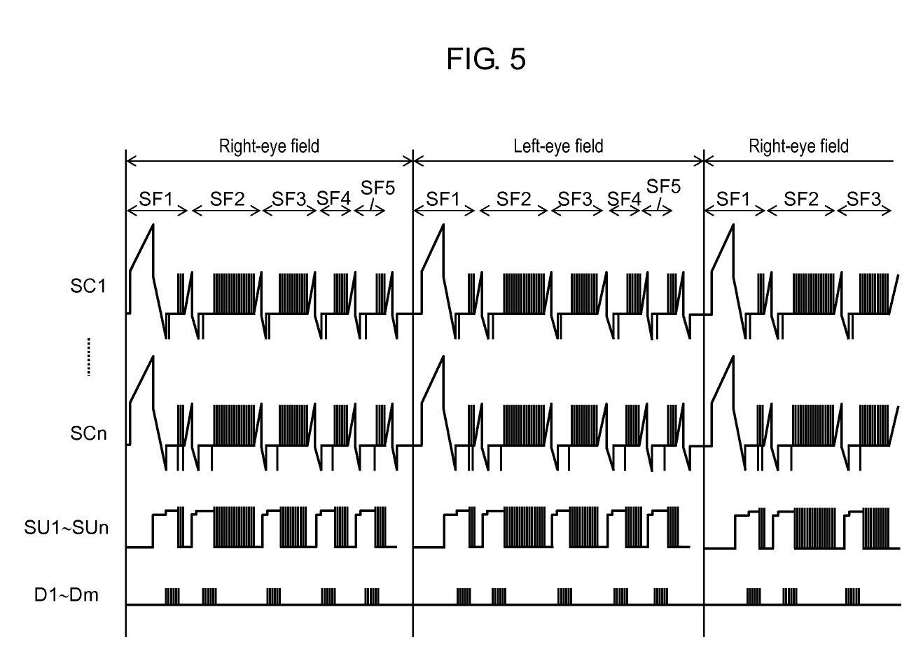

According to the present embodiment, a field frequency is set to 120 Hz which is twice of a normal frequency to display a three-dimensional image, and right-eye fields and left-eye fields are alternately arranged as illustrated in FIG. 5. One field includes five sub fields (SF1, SF2, SF3, SF4, and SF5).

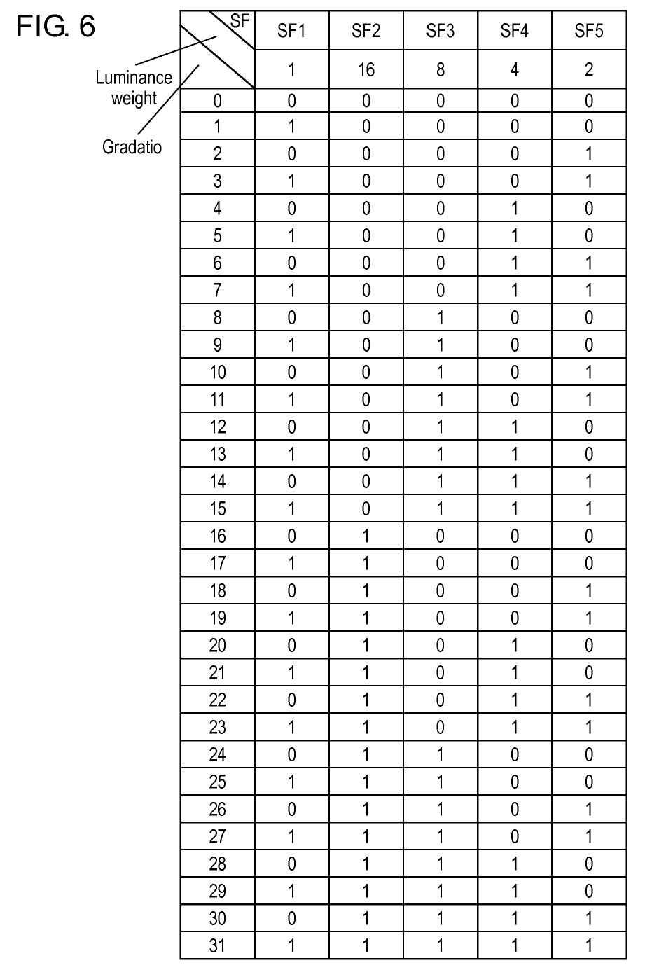

As illustrated in FIG. 6, one field includes, for example, five sub fields (SF1, SF2, SF3, SF4, and SF5). During the initializing period of SF1 which is a top sub field in a field, the forced initializing operation is carried out. During the initializing period of SF2 to SF5 which are sub fields that follow SF1, the selective initializing operation is carried out.

The luminance weight in SF1 is 1. The luminance weight in SF2 is 16. The luminance weight in SF3 is 8. The luminance weight in SF4 is 4. The luminance weight in SF5 is 2. Thus, the top sub field, SF1, has the smallest luminance weight. The second sub field, SF2, has the largest luminance weight. The luminance weight is increasingly smaller in the third sub field and the sub fields thereafter. The luminance weights in the sub fields are thus set.

The liquid crystal shutter R for right eye and the liquid crystal L shutter for left eye of the shutter glasses receive the timing signals outputted from the timing signal output unit to control the shutter glasses as described below. The liquid crystal shutter R for right eye of the shutter glasses opens as soon as the address period of the right-eye field SF1 starts but closes as soon as the address period of the left-eye field SF1 starts. The liquid crystal shutter L for left eye of the shutter glasses opens as soon as the address period of the left-eye field SF1 starts but closes as soon as the address period of the right-eye field SF1 starts.

As a result of the sub fields thus arranged and the shutter glasses thus controlled, crosstalk between the right-eye image and the left-eye image is prevented from happening. Further, the address discharge thus stabilized can display a three-dimensional image with a high quality.

The afterglow intensity of a phosphor is proportional to a degree of luminance when the phosphor becomes luminescent. The afterglow intensity of a phosphor attenuates with a predetermined time constant. The luminance of luminescence during the sustain period is higher in the sub fields where the luminance weight is larger. To weaken the afterglow, therefore, it is desirable to arrange the sub fields where the luminance weight is larger in an early stage of the field.

In the discharge cells which display bright gradation, the sustain discharge is generated in a plurality of sub fields. Therefore, the discharge cells are supplied with ample priming to compensate for the sustain discharge, so that the address discharge generated therein is stabilized. However, there is not enough priming in the discharge cells which display dark gradation, particularly in the discharge cell to become luminescent only in the field having the smallest luminance weight, which easily destabilizes the address discharge.

In the present embodiment, therefore, the first sub field where the forced initializing operation is carried out during the initializing period has the smallest luminance weight to generate the address discharge before the priming generated during the forced initializing operation is consumed. Then, the wiring discharge can be generated in a stable manner in the discharge cell to become luminescent only in the sub field having the smallest luminance weight. The second sub field has the largest luminance weight, and the luminance weight is increasingly smaller in the third sub field onwards. Therefore, the phosphor afterglow can be weakened when the field ends, and crosstalk between the right and left eyes can be prevented from happening.

3-1-6. Gradation Display Method

In a table of FIG. 6 illustrating a relationship between gradation levels to be displayed and whether the address operation in the sub field then is carried out (hereinafter, called coding), “1” indicates that the address operation is carried out, and “0” indicates that the address operation is not carried out.

Referring to the coding, the address operation is not carried out in any of the sub fields SF1 to SF5 in the discharge cell displaying the gradation “0”, more specifically, in the discharge cell representing black. As a result, the discharge cell never generates the sustain discharge, thereby exerting the lowest luminance in display.

In the discharge cell displaying the gradation “1”, the address operation is carried out in SF5 alone which is the sub field having the luminance weight “1”, but the address operation is not carried out in SF1 to SF4. Then, the discharge cell generates the sustain discharge a number of times comparable to the luminance weight “1”, thereby exerting the luminance “1” in display.

In the discharge cell displaying the gradation “7”, the address operation is carried out in SF3 having the luminance weight “4”, SF4 having the luminance weight “2”, and SF5 having the luminance weight “1”. Then, the discharge cell generates the sustain discharge a number of times comparable to the luminance weight “4” during the sustain period of SF3, generates the sustain discharge a number of times comparable to the luminance weight “2” during the sustain period of SF4, and generates the sustain discharge a number of times comparable to the luminance weight “1” during the sustain period of SF5. Therefore, the discharge cell exerts the luminance “7” in total in display.

The description given so far is applied to other gradation levels. In accordance with the coding illustrated in FIG. 6, whether the sustain discharge is generated is controlled depending on whether the address operation is carried out in the relevant sub fields.

4. Production Method of PDP 1

4-1. Production Method of Front Plate 2

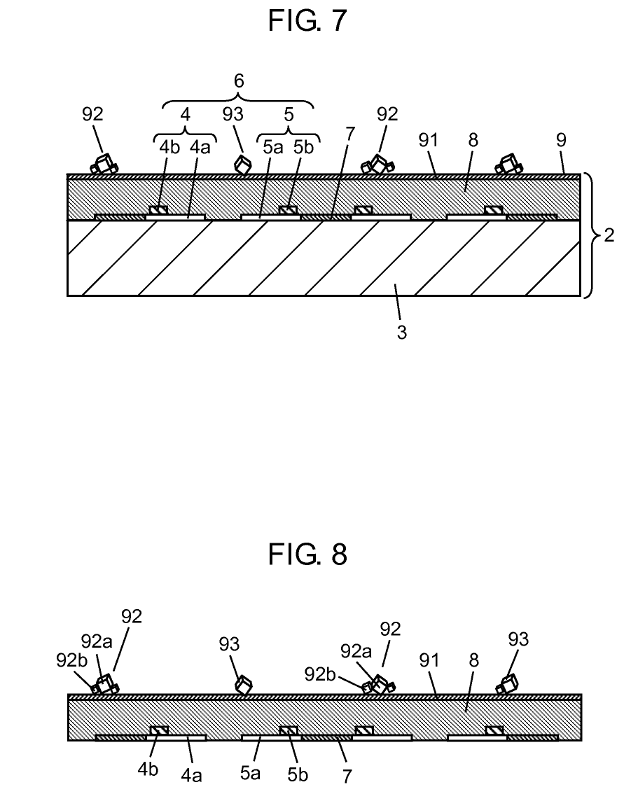

Scan electrodes 4, sustain electrodes 5, and black stripes 7 are formed on front glass substrate 3 by photolithography. As illustrated in FIG. 7, scan electrode 4 and sustain electrode 5 respectively have metal bus electrodes 4b and 5b including silver (Ag) to ensure an electrical conductivity. Scan electrode 4 and sustain electrode 5 further have transparent electrodes 4a and 5a. Metal bus electrode 4b is provided on transparent electrode 4a, and metal bus electrode 5b is provided on transparent electrode 5a.

A material used to form transparent electrodes 4a and 5a is, for example, ITO to ensure a transparency and an electrical conductivity. First, an ITO thin film is formed on front glass substrate 3 by, for example, sputtering. Then, transparent electrodes 4a and 5a are formed in a predetermined pattern by lithography. A material used to form metal bus electrodes 4b and 5b is, for example, a metal bus electrode paste containing silver (Ag), a glass frit to bind the silver, a photosensitive resin, and a solvent. The metal bus electrode paste is spread on front glass substrate 3 by screen printing. Then, the solvent in the metal bus electrode paste is removed in a baking oven, and the electrodes paste is exposed to light via a photo mask formed in a predetermined pattern.

Then, the metal bus electrode paste is developed so that a metal bus electrode pattern is formed. Lastly, the metal bus electrode pattern is fired in a baking oven at a predetermined temperature so that the photosensitive resin in the metal bus electrode pattern is removed. Further, the glass frit in the metal bus electrode pattern is melted, and the melted glass frit starts to vitrify again after the firing. As a result of these steps, metal bus electrodes 4b and 5b are formed.

Black stripes 7 are formed from a material containing a black pigment.

Next, dielectric layer 8 is formed. A material used to form dielectric layer 8 is, for example, a dielectric paste containing a dielectric glass frit, a resin, and a solvent. First, the dielectric paste is spread in a predetermined thickness by die coating on front glass substrate 3 so as to cover scan electrodes 4, sustain electrodes 5, and black stripes 7. Then, the solvent in the dielectric paste is removed in a baking oven. Lastly, the dielectric paste is fired at a predetermined temperature in a baking oven so that the resin in the dielectric paste is removed. Further, the dielectric glass frit is melted, and the melted glass frit starts to vitrify again after the firing. As a result of these steps, dielectric layer 8 is formed. In place of die coating employed to apply the dielectric paste, screen printing or spin coating may be employed. Instead of using the dielectric paste, a film used as dielectric layer 8 may be formed by, for example, CVD (Chemical Vapor Deposition).

Then, protective layer 9 is formed on dielectric layer 8. A detailed description of protective layer 9 will be given later.

Through the above steps, the production of front plate 2 where the structural elements described so far are provided on front glass substrate 3 is completed.

4-2. Production Method of Rear Plate 10

Data electrodes 12 are formed on rear glass substrate 11 by photolithography. A material used to form data electrodes 12 is, for example, a data electrode paste containing silver (Ag) to ensure conductivity, a glass frit to bind the silver, a photosensitive resin, and a solvent. First, the data electrode paste is spread in a predetermined thickness on rear glass substrate 11 by screen printing, and the solvent in the data electrode paste is removed in a baking oven. Then, the data electrode paste is exposed to light via a photo mask formed in a predetermined pattern, and the data electrode paste is developed so that a data electrode pattern is formed. Lastly, the data electrode pattern is fired in a baking oven at a predetermined temperature so that the photosensitive resin in the data electrode pattern is removed. Further, the glass frit in the data electrode pattern is melted, and the melted glass frit starts to vitrify again after the firing. As a result of these steps, data electrodes 12 are formed. In place of screen printing employed to apply the data electrode paste, sputtering or vapor deposition may be employed.

Next, insulating layer 13 is formed. A material used to form insulating layer 13 is, for example, a base dielectric paste containing a dielectric glass frit, a resin, and a solvent. First, the base dielectric paste is spread in a predetermined thickness on rear glass substrate 11 provided with data electrodes 12 by screen printing so as to cover data electrodes 12. Then, the solvent in the base dielectric paste is removed in a baking oven, and the base dielectric paste is fired in a baking oven at a predetermined temperature so that the resin in the base dielectric paste is removed. Further, the glass frit in the base dielectric paste is melted, and the melted glass frit starts to vitrify again after the firing. As a result of these steps, insulating layer 13 is formed. In place of screen printing employed to apply the base dielectric paste, die coating or spin coating may be employed. Instead of using the base dielectric paste, a film used as insulating layer 13 may be formed by, for example, CVD (Chemical Vapor Deposition).

Next, barrier ribs 14 are formed by photolithography. A material used to form barrier ribs 14 is, for example, a barrier rib paste containing a filler, a glass frit to bind the filler, a photosensitive resin, and a solvent. The barrier rib paste is spread on insulating layer 13 in a predetermined thickness by die coating. Then, the solvent in the barrier rib paste is removed in a baking oven, and the barrier rib paste is exposed to light via a photo mask formed in a predetermined pattern. The barrier rib paste is then developed so that a barrier rib pattern is formed. Lastly, the barrier rib pattern is fired at a predetermined temperature in a baking oven so that the photosensitive resin in the barrier rib pattern is removed. Further, the glass frit in the barrier rib pattern is melted, and the melted glass frit starts to vitrify again after the firing. As a result of these steps, barrier ribs 14 are formed. The photolithography may be replaced with, for example, sandblasting.

Next, phosphor layers 15 are formed. A material used to form phosphor layers 15 is, for example, a phosphor paste containing phosphor particles, a binder, and a solvent. The phosphor paste is spread by dispensing in a predetermined thickness on insulating layer 13 between adjacent barrier ribs 14 and side surfaces of barrier ribs 14. Then, the solvent in the phosphor paste is removed in a baking oven. Lastly, the phosphor paste is fired at a predetermined temperature in a baking oven so that the resin in the phosphor paste is removed. As a result of these steps, phosphor layers 15 are formed. The dispensing may be replaced with, for example, screen printing. Phosphor layers 15 will be described in further detail later.

As a result of the steps described so far, the production of rear plate 10 where the structural elements described so far are provided on rear glass substrate 11 is completed.

4-3. Assembling Method of Front Plate 2 and Rear Plate 10

Then, front plate 2 and rear plate 10 are put together. First, a sealing member (not illustrated in the drawings) is formed in a peripheral portion of rear plate 10 by dispensing. The sealing member (not illustrated in the drawings) is a sealing paste containing a glass frit, a binder, and a solvent. The solvent in the sealing paste is removed in a baking oven. Next, front plate 2 and rear plate 10 are disposed facing each other so that display electrodes 6 and data electrodes 12 are orthogonal to each other. Then, the peripheral portions of front plate 2 and rear plate 10 are sealed with the glass frit. Lastly, a discharge gas containing, for example, Ne, Xe is enclosed in discharge space 16. Then, the production of PDP 1 is completed.

5. Detail of Dielectric Layer 8

The dielectric material includes the following components; bismuth oxide (Bi₂O₃) by 20 wt. % to 40 wt. %, at least one selected from calcium oxide (CaO), strontium oxide (SrO), and barium oxide (BaO) by 0.5 wt. % to 12 wt. %, at least one selected from molybdenum oxide (MoO₃), tungsten oxide (WO₃), cerium oxide (CeO₂), and manganese dioxide (MnO₂) by 0.1 wt. % to 7 wt. %, zinc oxide (ZnO) by 0 wt. % to 40 wt. %, boron oxide (B₂O₃) by 0 wt. % to 35 wt. %, silicon dioxide (SiO₂) by 0 wt. % to 15 wt. %, and aluminum oxide (Al₂O₃) by 0 wt. % to 10 wt. %. The dielectric material substantially does not include any lead component.

Dielectric layer 8 has a film thickness equal to or smaller than 40 μm, and dielectric constant ∈ of dielectric layer 8 is at least 4 to at most 7. A reason why dielectric constant ∈ of dielectric layer 8 is set to at least 4 to at most 7 will be described later.

The dielectric material having such a composition is ground by a wet jet mill or ball mill so that an average particle diameter is 0.5 μm to 2.5 μm. As a result, dielectric material powder is obtained. Then, 55 wt. % to 70 wt. % of the dielectric material powder and 30 wt. % to 45 wt. % of a binder component are kneaded by a three-roll mill so that a first paste for dielectric layer for die coating or printing is prepared.

The binder component is ethyl cellulose, or terpineol or butyl carbitol acetate including acrylic resin by 1 wt. % to 20 wt. %. If, necessary, dioctyl phthalate, dibutyl phthalate, triphenyl phosphate, or tributyl phosphate may be further added to the paste as a plasticizer, and glycerol mono-oleate, sorbitan sesquioleate, HOMOGENOL (product supplied by Kao Corporation), alkylaryl phosphate, or the like may be further added to the paste as a dispersant. The addition of the dispersant improves a level of printability.

6. Detail of Protective Layer 9

There are four main functions exerted by the protective layer; 1) protect the dielectric layer from the impact of ions through the electric discharge, 2) release primary electrons to cause address discharge, 3) retain charges for causing the electric discharge, and 4) release secondary electrons during sustain discharge. Because the dielectric layer is protected from the ion-induced impact, a discharge voltage is prevented from increasing. As more primary electrons are released, an address discharge error, which is a factor responsible for flickering images, is less likely to occur. Improvement of a charge retainability reduces the voltage to be applied, and it reduces a sustain discharge voltage to release more secondary electrons. An attempt for increasing the primary electrons to be released is to add, for example, silicon (Si) or aluminum (Al) to MgO of the protective layer.

The improvement of the primary electron releasability by mixing the impurity with MgO increases an attenuation factor by which the electric charges stored in the protective layer reduces with time. This requires such a countermeasure as increasing the applied voltage to compensate for the attenuated electric charges. It is demanded that the protective layer meet two contradictory requirements; high primary electron releasability, and small charge attenuation factor, in other words, high charge retainability.

In the case where a discharge delay occurs in a high-speed drive with a short address period in which, for example, the right-eye field and the left-eye field are alternately and repeatedly displayed, an address error occurs, in other words, flickering images are displayed.

6-1. Structure of Protective Layer 9

As illustrated in FIG. 8, protective layer 9 includes base film 91 which is a base layer, aggregated particles 92 which are first particles, and crystal particles 93 which are second particles. Base film 91 is, for example, a magnesium oxide (MgO) film including aluminum (Al) as an impurity. Aggregated particle 92 is formed by aggregating a MgO crystal particle 92a and a plurality of crystal particles 92b. Each of crystal particles 92b has particle diameters smaller than MgO crystal particles 92a. Crystal particle 93 is a crystal particle made of MgO and having a cubic shape. The shape of crystal particle 93 can be confirmed by a scanning electron microscope (SEM). According to the present embodiment, a plurality of aggregated particles 92 is dispersed on the entire surface of base film 91, and a plurality of crystal particles 93 is also dispersed on the entire surface of base film 91.

Crystal particles 92a have an average particle diameter in the range of 0.9 μm to 2 μm. Crystal particles 92b have an average particle diameter in the range of 0.3 μm to 0.9 μm. The average particle diameter recited in the present embodiment is a volume cumulative diameter (D50). To measure the average particle diameter, a laser diffraction particle size distribution analyzer MT-3300 (supplied by NIKKISO CO., LTD was used.

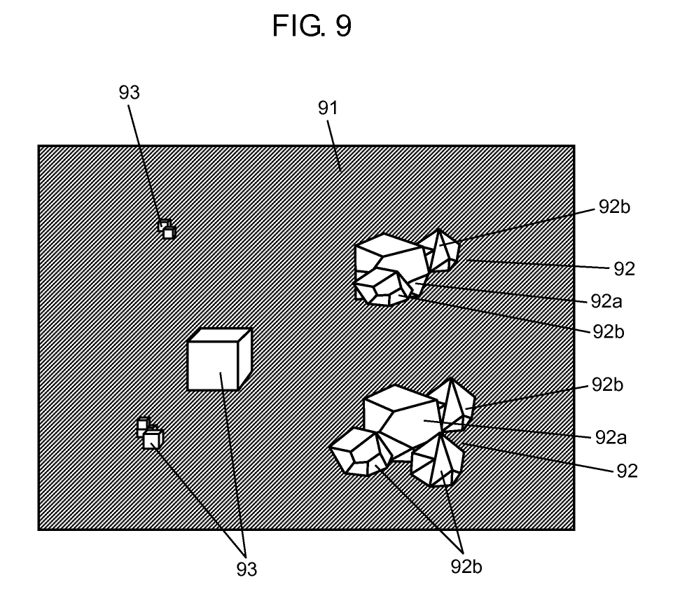

On the surface of protective layer 9, aggregated particles 92 in which a plurality of crystal particle 92b having a polyhedral shape is aggregating to crystal particle 92a similarly having a polyhedral shape, and crystal particles 93 having a cubic shape are dispersed on base film 91 as illustrated in FIG. 9. Cubic crystal particles 93 include particles having particle diameters of about 200 nm and nano-sized particles having particle diameters of at most 100 nm. The observation of PDP 1 confirmed the presence of cubic crystal particles 93 aggregating to one another, polyhedral crystal particles 92a or polyhedral crystal particles 92b alone, and aggregated particles 92 having polyhedral crystal particles 92a and 92b to which cubic crystal particle 93 of MgO adhere. Polyhedral crystal particles 92a and 92b were produced by a liquid-phase technique, and cubic crystal particles 93 were produced by a vapor-phase technique.

The cubic shape does not necessarily mean a geometrically strict cubic shape, but means a shape that can be recognized as a cubic shape through visual observation of an electronic microscopic image. The polyhedral shape means a shape that can be recognized as having at least seven surfaces through visual observation of an electronic microscopic image.

6-2. Aggregated Particles 92

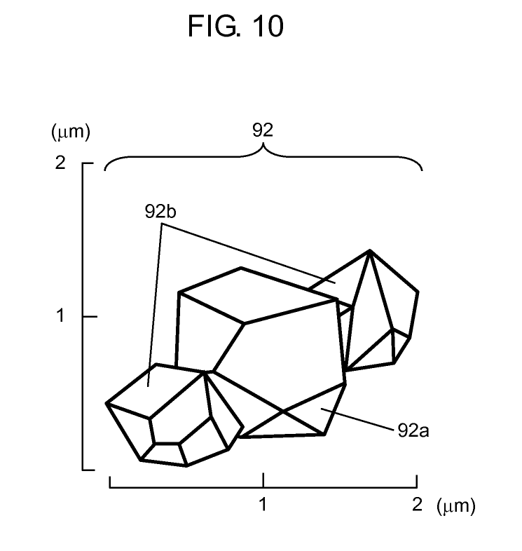

As illustrated in FIG. 10, aggregated particle 92 has a plurality of crystal particles 92a and 92b having predefined primary particle diameters aggregating to one another, or a plurality of crystal particles 92a having predefined primary particle diameters aggregating to one another. In aggregated particle 92, the particles are not bonded to one another by a strong binding force as a solid matter. Aggregated particles 92 are each an assembly of primary particles gathered by static electricity or van der Waals force. More specifically, the particles are bound by such an external force, for example, supersonic wave, that all or a part of aggregated particle 92 is disassembled into primary particles. Aggregated particles 92 have particle diameters of approximately 1 μm. Crystal particles 92a and 92b have a polyhedral shape having at least seven surfaces such as cuboctahedron or dodecahedron. Crystal particles 92a and 92b were produced by a liquid-phase technique in which an MgO precursor solution including, for example, magnesium carbonate or magnesium hydrate is fired. The particle diameters can be controlled by adjusting a firing temperature and firing atmosphere in the liquid-phase technique. The firing temperature can be selected from the temperature range of about 700° to about 1,500° C. The firing temperatures equal to or higher than 1,000° C. can control the primary particle diameters to 0.3 μm to 2 μm. In the production process where the liquid-phase technique is employed, crystal particles 92a and 92b can be obtained in the form of aggregated particles 92 where a plurality of primary particles is aggregating to one another.

On the other hand, cubic crystal particles 93 are obtained in a vapor-phase technique in which magnesium is heated to reach a boiling point to generate magnesium vapor for vapor-phase oxidation. The particles thereby obtained are cubic crystal particles having a monocrystal structure and having particle diameters equal to or larger than 200 nm (measurement result by BET), and crystal particles having a polycrystal structure where crystals are fitted into one another. The magnesium powder synthesizing method by vapor-phase technique was disclosed in, for example, an academic journal, “Materials”, “Synthesis of Magnesia Powder by Vapor-Phase Technique and Properties” Issue No. 410, volume 36.

To form cubic crystal particles having a monocrystal structure and having an average particle diameter equal to or larger than 200 nm, a heating temperature when the magnesium vapor is generated is increased to lengthen flames where magnesium and oxygen react with each other. As a temperature difference between the flames and the environment is thus increased, MgO crystal particles having larger particle diameters can be obtained by the vapor-phase technique.

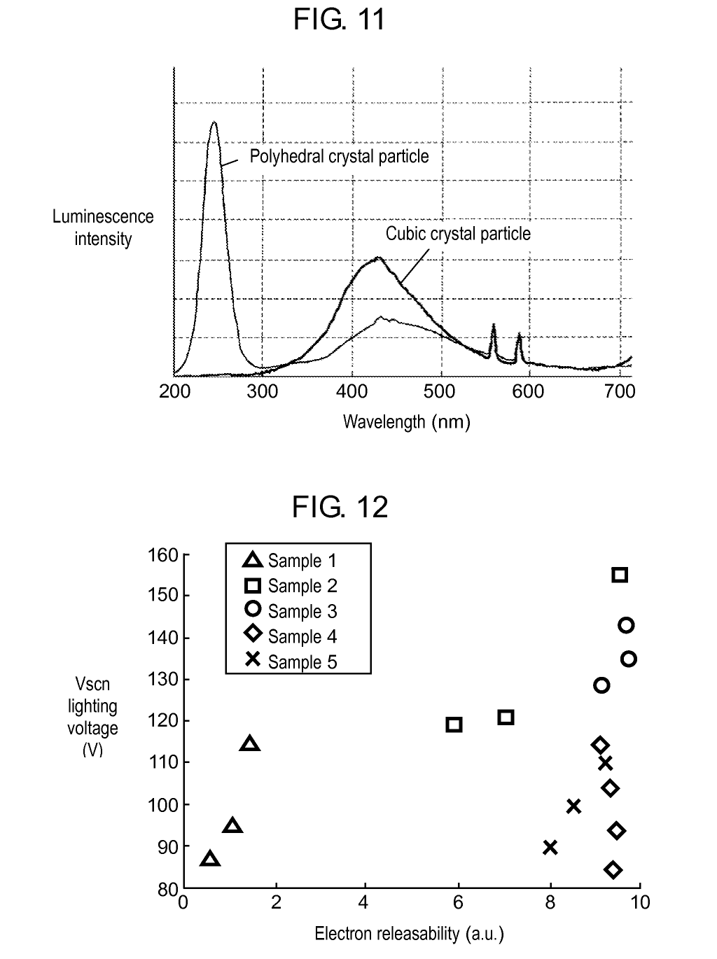

The cathode luminescence (CL) characteristics were measured for polyhedral crystal particles 92a and 92b and cubic crystal particles 93. As illustrated in FIG. 11, a thin solid line shows the luminescence intensity of MgO polyhedral crystal particles 92a and 92b, which is the cathode luminescence intensity of aggregated particles 92. A bold solid line shows the cathode luminescence intensity of MgO cubic crystal particles 93.

As illustrated in FIG. 11, aggregated particles 92 having polyhedral crystal particles 92a and 92b aggregating to one another have a luminescence intensity peak in the wavelength region of at least 200 nm to at most 300 nm, particularly in the wavelength region of at least 230 nm to at most 250 nm. MgO cubic crystal particles 93 does not have a luminescence intensity peak in the wavelength region of at least 200 nm to at most 300 nm but in the wavelength region of at least 400 nm to at most 450 nm. Aggregated particles 92 having polyhedral crystal particles 92a and 92b aggregating to one another and MgO cubic crystal particles 93 which adhere to base film 91 have energy levels corresponding to the wavelengths of the luminescence intensity peaks.

7. Sample Evaluation Result

7-1. Sample Structures

A plurality of PDPs respectively having protective layers differently formed was prepared as samples.

Sample 1 is a PDP having a protective layer including MgO alone.

Sample 2 is a PDP having a protective layer including MgO alone doped with such an impurity as Al or Si.

Sample 3 is a PDP where the primary particles alone of crystal particles made of a metallic oxide are dispersed on an MgO base film.

Sample 4 is PDP 1 where aggregated particles 92 including MgO crystal particles having equal particle diameters and aggregating to one another adhere to the entire surface of base film 91 made of MgO. Thus, Sample 4 is PDP 1 where a plurality of aggregated particles 92 is dispersed on all over base film 91.

Sample 5 is a PDP having protective layer 9 where polyhedral aggregated particles 92 including MgO crystal particles 92b having particle diameters smaller than crystal particles 92a and aggregating to one another around MgO crystal particles 92a having an average particle diameter in the range of 0.9 μm to 2 μm, and cubic MgO crystal particles 93 adhere to the entire surface of base film 91 made of MgO. Thus, Sample 5 is PDP 1 where a plurality of aggregated particles 92 and a plurality of crystal particles 93 are dispersed on all over the surface of base film 91. In PDP 1 of Sample 5, a plurality of aggregated particles 92 and a plurality of crystal particles 93 are preferably evenly dispersed on all over the surface of base film 91 because variability of in-plane discharge characteristics of PDP 1 can be thereby controlled.

7-2. Performance Evaluation

The electron releasability and charge retainability were measured in these Samples 1 to 5.

As a numeral value of the electron releasability is larger, more electrons are released. A primary electron release amount determined by a discharge surface condition, type of gas, and condition of gas is used to express the electron releasability. The primary electron release amount can be measured by measuring an amount of electron current released from a surface when ion or electronic beam is applied thereto, however, it is difficult to perform the measurement in a non-destructive approach. Therefore, the method disclosed in Unexamined Japanese Patent Publication No. 2007-48733 was used. Of delay times during the electric discharge, a numeral value as an indicator of a degree of dischargeability, called a statistical delay time, was measured. When an inverse number of the statistical delay time is integrated, a numeral value linearly corresponding to the primary electron release amount is obtained. The discharge delay time is a delay time of the address discharge from the rise of an address discharge pulse. A main likely cause of the discharge delay is that there is some difficulty in the release of primary electrons which trigger the address discharge from the surface of a protective layer into a discharge space.

An indicator used to evaluate the charge retainability is a voltage value of a voltage (hereinafter, called Vscn lighting voltage) applied to the scan electrodes to control the charge release when the PDP is produced. The lower the Vscn lighting voltage is, the higher the charge retention ability is. When the Vscn lighting voltage is low, the PDP can be driven at a low voltage. Thus, any parts having a lower breakdown voltage and a smaller capacity can be used as a power supply and electric components. Among the products currently available, devices having a breakdown voltage of approximately 150 V are used as a semiconductor switching element such as a MOSFET provided to sequentially apply the scan voltage to the panel. The Vscn lighting voltage is desirably at most 120 V in view of temperature-dependent variability.

As is clear from FIG. 12, Samples 4 and 5 were evaluated for the charge retainability, and it was learnt that these samples succeeded in reducing the Vscn lighting voltage to at most 120 V and obtaining such favorable characteristics as the electron releasability equal to or higher than 6.

In general, the electron releasability and the charge retainability of a protective layer in the PDP contradict with each other. When, for example, deposition conditions of the protective layer are changed or the protective layer is doped with an impurity such as Al, Si, or Ba in a film formation process, the electron releasability can be improved. This, however, brings an adverse effect, which is increase of the Vscn lighting voltage.

PDP 1 having protective layer 9 according to the present embodiment can attain the electron releasability equal to or higher than 6 and such a charge retainability that the Vscn lighting voltage is at most 120 V. More specifically, protective layer 9 thus obtained has the electron releasability and the charge retainability which are good enough for any PDP wherein there are more scan lines to meet the demand of a higher definition and a cell size is increasingly reduced.

Next, aged deterioration of the electron releasability in protective layer 9 was studied, and a study result thereby obtained is described below. For a better lifetime of the PDP, aged deterioration of the electron releasability in protective layer 9 is desirably avoided.

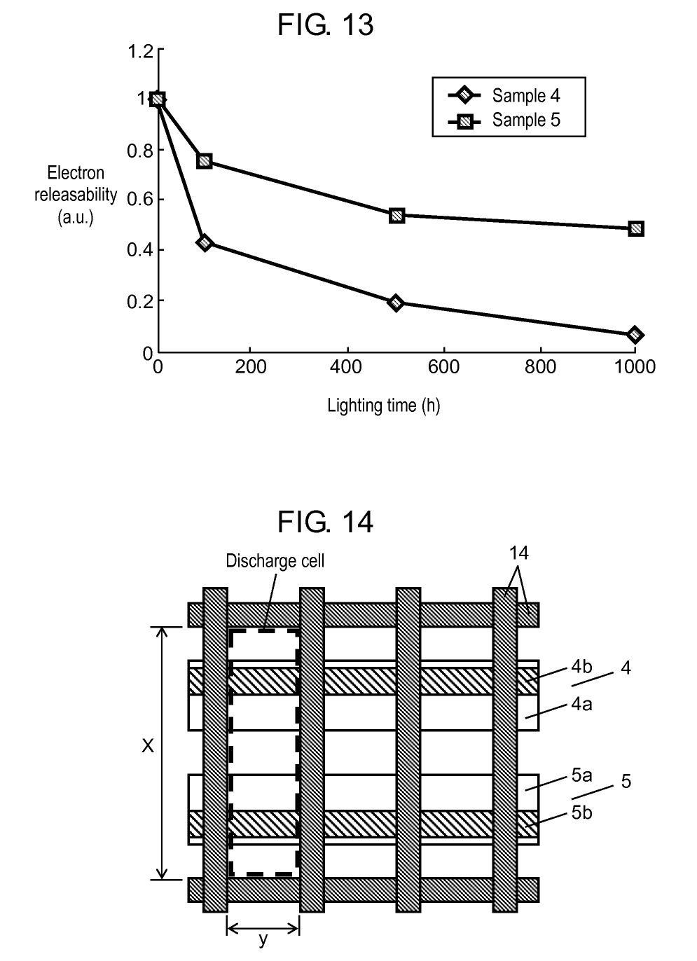

The aged deterioration of the electron releasability was studied in Samples 4 and 5 from which the favorable results of FIG. 12 were obtained. FIG. 13 is a graph of a study result thereby obtained, illustrating transition of the electron releasability relative to lighting time of the PDP. As illustrated in FIG. 13, as compared to Sample 4, there is less aged deterioration of the electron releasability in Sample 5 in which polyhedral aggregated particles 92 including MgO crystal particles 92b having particle diameters smaller than crystal particles 92a and aggregating to one another around MgO crystal particles 92a having an average particle diameter in the range of 0.9 μm to 2 μm, and cubic MgO crystal particles 93 adhere to the entire surface of base film 91 including MgO.

In Sample 4, it appears that the ions generated by the electric discharge in the PDP cells impact the protective layer, causing aggregated particles 92 to be removed from the protective layer. Meanwhile, in Sample 5, MgO crystal particles 92b having an average particle diameter smaller than crystal particles 92a are aggregating to one another around MgO crystal particles 92a having an average particle diameter in the range of 0.9 μm to 2 μm. That is, crystal particles 92b having relatively small particle diameters have a large surface area, increasing the adhesiveness to base film 91. This is a probable reason why there are not many aggregated particles 92 removed by the impact of ions.

The PDP of Sample 5, wherein aged deterioration of the electron releasability is reduced, can achieve a stable image quality over a long period of time.

According to the present embodiment, aggregated particles 92 and crystal particles 93 adhere to all over the surface of base film 91 by a coating ratio in the range of at least 10% to at most 20%. The coating ratio is a percentage representation of an area a in the region of a single discharge cell to which aggregated particles 92 and crystal particles 93 adhere to an area b of the single discharge cell; coating ratio (%)=a/b×100. An actual measurement method is described below. As illustrated in FIG. 14, an image of a region comparable to a discharge cell divided by barrier ribs 14 is captured and trimmed to the size of a cell, x×y. Then, the trimmed image is binalized into white and black data. Based on the binarized data, a black area a of aggregated particles 92 and crystal particles 93 is obtained, and the coating ratio is calculated by the formula, a/b×100.

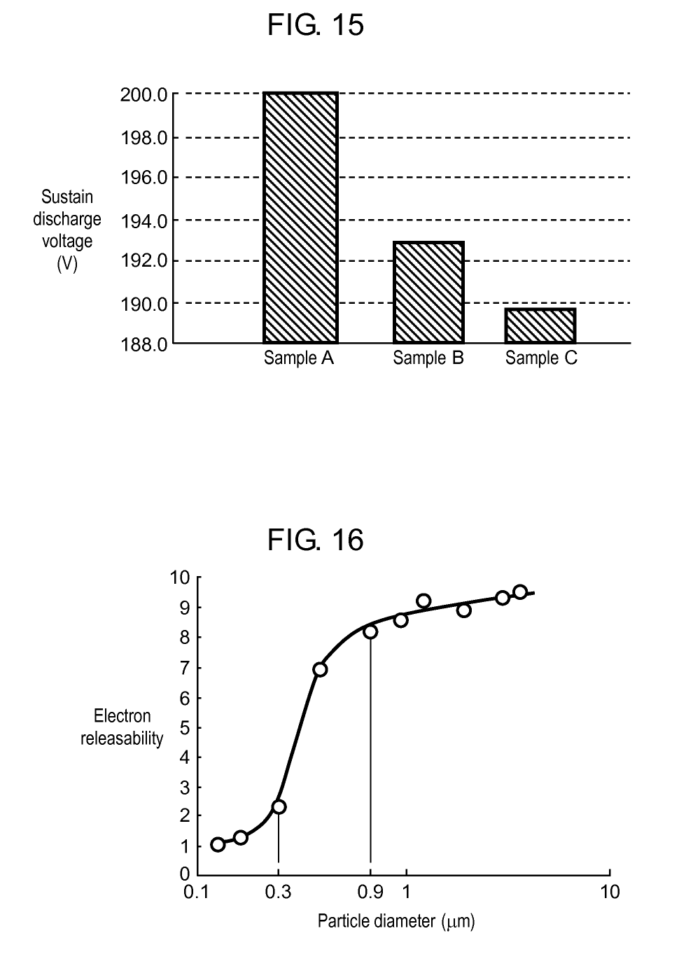

To confirm the effect of the PDP having the protective layer to which polyhedral crystal particles 92a and 92b and cubic crystal particles 93 adhere, samples were further produced to check their respective sustain discharge voltages. As illustrated in FIG. 15, Sample A is a PDP where only aggregated particles 92 including MgO crystal particles 92a and 92b having a peak of the CL in the wavelength region of at least 200 nm to at most 300 nm are dispersed on and adhere to MgO base film 91. In both of PDPs of Samples B and C, aggregated particles 92 where polyhedral MgO crystal particles 92b having particle diameters smaller than crystal particles 92a and aggregating to one another around polyhedral MgO crystal particles 92a having an average particle diameter in the range of 0.9 μm to 2 μm, and cubic MgO crystal particles 93 adhere to all over the surface of MgO base film 91. In Samples B and C, however, dielectric constant ∈ of dielectric layers 8 has different values. Dielectric layer 8 of Sample B has dielectric constant ∈ of about 9.7, and dielectric layer 8 of Sample C has dielectric constant ∈ of 7. The coating ratio is about 13% which is far below 20% in both of the samples.

As illustrated in FIG. 15, Samples B and C succeeded in reducing the sustain discharge voltage as compared to Sample A. More specifically, the sustain discharge voltage can be reduced, meaning that power consumption of the PDP can be reduced in the PDP having the protective layer to which aggregated particles 92 including polyhedral MgO crystal particles 92a and 92b characterized in that the CL peak stays in the wavelength region of at least 200 nm to at most 300 nm, and cubic MgO crystal particles 93 characterized in that the CL peak stays in the wavelength region of at least 400 nm to at most 450 nm adhere. As is clear from the characteristics of Samples B and C, there is more reduction of the sustain discharge voltage as dielectric constant c of dielectric layer 8 is lower. Through the tests, the present inventors learnt that the effect was more remarkable when dielectric constant c of dielectric layer 8 was at least 4 to at most 7.

FIG. 16 illustrates a test result of the electron releasability when the average particle diameter of MgO aggregated particles 92 in the protective layer was changed. The average particle diameter of aggregated particles 92 illustrated in FIG. 16 was measured through observation of aggregated particles 92 by SEM.

As illustrated in FIG. 16, the electron releasability declines when the average particle diameter is as small as about 0.3 μm, and the electron releasability can gain an expected high level when the average particle diameter is at least about 0.9 μm.

To increase the number of electrons released in the discharge cell, number of crystal particles per unit area of protective layer 9 is desirably larger. It was learnt from the tests conducted by the present inventors that top portions of barrier ribs 14 may be broken in the case where crystal particles 92a, 92b, and 93 are present at or near the top portions of barrier ribs 14 in close contact with protective layer 9, in which case the material of broken barrier ribs 14 might drop on the phosphors, possibly failing to light on or off any relevant cell. Such an unfavorable event as the breakage of the barrier rib is unlikely to occur as far as crystal particles 92a, 92b, and 93 are not present at or near the top portions of the barrier ribs, meaning that the probability of the breakage of barrier ribs 14 is higher as more crystal particles adhere to the layer.

As illustrated in FIG. 17, the probability of the barrier rib breakage soars when the particle diameters are as larger as about 2.5 μm, while the probability of the barrier rib breakage is relatively small as far as the particle diameters are smaller than 2.5 μm.

Based on the facts thus learnt, aggregated particles 92 desirably have an average particle diameter in the range of at least 0.9 μm to at most 2.5 μm. For mass production of the PDP, it is necessary to take into account production variability of crystal particles and production variability of the protective layer.

To further look into such a factor as the production variability, a test was conducted, in which crystal particles having different particle diameter distributions were used. It was learnt from the test that the effect described so far could be reliably obtained as far as aggregated particles 92 having an average particle diameter in the range of 0.9 μm to 2 μm were used.

8. Production Method of Protective Layer 9

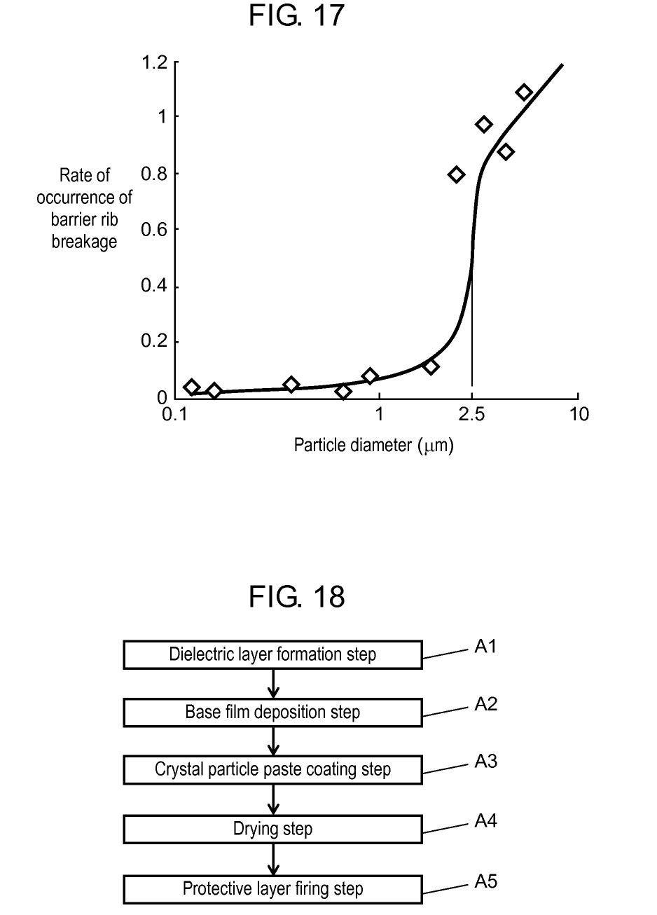

As illustrated in FIG. 18, in base film deposition step A2 subsequent to dielectric layer formation step A1 in which dielectric layer 8 is formed, base film 91 including MgO containing Al as an impurity is formed on dielectric layer 8 by vacuum deposition which uses an MgO sintered member containing Al as a raw material.

Then, a plurality of aggregated particles 92 and a plurality of crystal particle 93 are scattered on and adhere to base film 91 still unfired. Aggregated particles 92 and crystal particle 93 are dispersed on the entire surface of base film 91.

First, an aggregated particle paste is prepared by dissolving polyhedral crystal particles 92a and 92b having a predetermined particle diameter distribution in a solvent, and a crystal particle paste is prepared by dissolving cubic crystal particles 93 in a solvent. Thus, the aggregated particle paste and the crystal particle paste are separately prepared. Then, the aggregated particle paste and the crystal particle paste are mixed with each other to obtain a mixed crystal particle paste in which polyhedral crystal particles 92a and 92b and cubic crystal particles 93 dissolved in the solvents are mixed with each other. In crystal particle paste coating step A3, the mixed crystal particle paste is spread on base film 91 so that a mixed crystal particle paste film having an average film thickness of 8 μm to 20 μm is formed. The mixed crystal particle paste is spread on base film 91 by such a coating method as screen printing, spraying, spin coating, die coating, or slit coating.

The solvents used in the production of the aggregated particle paste and the crystal particle paste preferably have a good affinity with MgO base film 91, aggregated particles 92, and crystal particles 93, and has a vapor pressure of approximately several ten Pa at normal temperature to facilitate the removal of vapor in drying step A4 that follows. Examples of the solvents are an organic solvent in which methyl methoxy butanol, terpineol, propylene glycol, or benzyl alcohol is dissolved as a single component, or a solvent in which these substances are mixed and dissolved. The pastes containing the solvents thus obtained have a viscosity in the range of several mPa·s to several ten mPa·s.

The substrate coated with the mixed crystal particle paste is immediately transferred to drying step A4. Drying step A4 dries the mixed crystal particle paste film under a reduced pressure. More specifically, the mixed crystal particle paste film is dried rapidly within several ten seconds in a vacuum chamber so that in-plane convection, which is a notable phenomenon in heat dry, does not occur. Therefore, aggregated particles 92 and crystal particles 93 adhere more evenly to base film 91. As drying method in drying step A4, heat dry may be employed depending on the solvents used to produce the mixed crystal particle paste.

In protective layer firing step A5, unfired base film 91 formed in base film deposition step A2 and the mixed crystal particle paste film dried in drying step A4 are fired at the same time at a temperature of several hundred degrees. The firing removes the solvents and resin component remaining in the mixed crystal particle paste film. As a result, protective layer 9 to which aggregated particles 92 including a plurality of polyhedral crystal particles 92a and 92b and cubic crystal particles 93 adhere is formed on base film 91.

According to the production method, aggregated particles 92 and crystal particles 93 can be dispersed on the entire surface of base film 91.

In addition to the above method, in place of using the solvents, these particles and a gas may be directly sprayed or the particles may be dispersed simply by gravity.

By using the aggregated particle paste alone in which polyhedral crystal particles 92a and 92b having the predefined particle diameter distribution are mixed with the solvent, aggregated particles 92 including crystal particles 92a and 92b aggregating to one another can be dispersed on the entire surface of base film 91.

Further, when the aggregated particle paste alone in which crystal particles 92a are dissolved in the solvent is used, aggregated particles 92 including a plurality of crystal particles 92a aggregating to one another can be dispersed on the entire surface of base film 91.

9. Green Phosphor

A green phosphor constituting green phosphor layer 32 according to the present embodiment is a phosphor including one of an Mn²⁺-activated short persistent green phosphor having a luminescence peak in the wavelength region of at least 500 nm to less than 560 nm and having an afterglow time exceeding 2 msec and staying below 5 msec, and a Ce³⁺-activated green phosphor or an Eu²⁺-activated green phosphor having a luminescence peak in the wavelength region of at least 490 nm to less than 560 nm. More specifically, to obtain the green phosphor, a predetermined amount of YAG phosphor which is an ultra-short persistent green phosphor is mixed with a short persistent ZSM phosphor in which the afterglow time is shortened by adjusting an Mn activation amount.

9-1. Mn Activation Amount of ZSM Phosphor

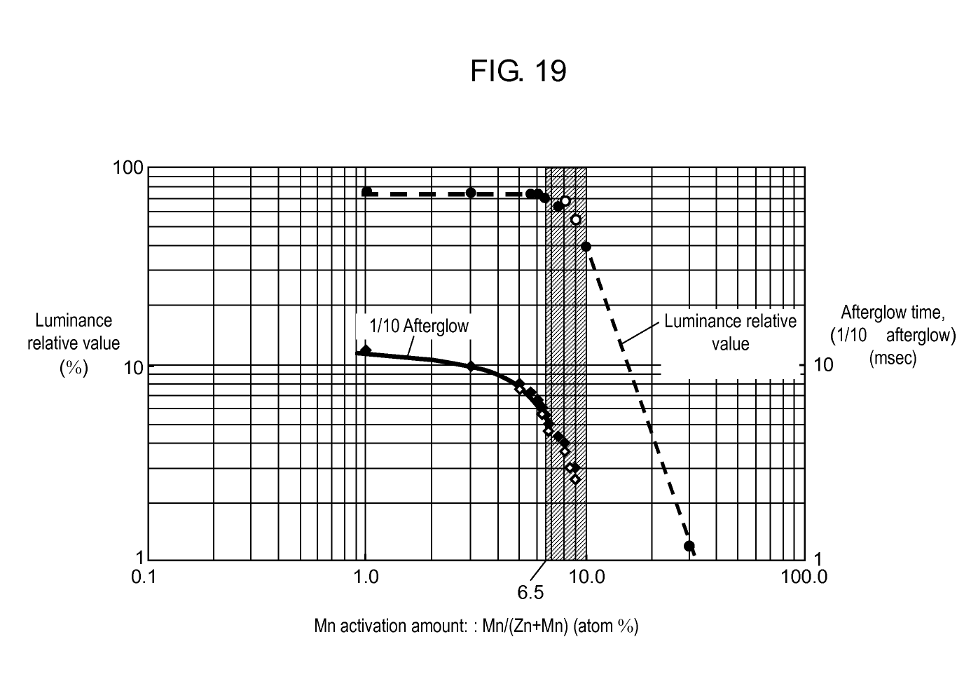

As illustrated in FIG. 19, the ZSM phosphor reduces its afterglow time and luminance as the Mn activation amount increases. The afterglow time shows a sharp drop when the Mn activation amount exceeds 4 atom %, and the luminance shows a sharp drop when the Mn activation amount exceeds 8 atom %. In an area having such a high Mn activation amount as exceeding 10 atom %, it is not possible to evaluate the afterglow time because of too a large drop of luminance.

The Mn activation amount is an atom % representation of a ratio of substitution of Mn atoms for Zn atoms of the ZSM phosphor (Mn/(Zn+Mn)). A result illustrated with black symbols ( and ♦) in FIG. 19 is an evaluation result of ZSM phosphor powder under the excitation by vacuum ultraviolet light (147 nm). White symbols (◯ and ⋄) represent an evaluation result of the ZSM phosphor powder when applied to the PDP. There is not a large difference between the result of the phosphor powder per se and the result thereof when applied to green phosphor layer 32 of the PDP.

As illustrated in FIG. 19, the Mn activation amount is set to at least 6.5 atom % to less than 10 atom %, the afterglow time can be controlled to be at least 2 msec to less than 5 msec. According to the present embodiment, the short persistent ZSM phosphor in which the Mn activation amount is at least 6.5 atom % to less than 10 atom % is defined as the Mn²⁺-activated short persistent green phosphor (hereinafter, called short persistent ZSM phosphor). The Mn activation amount of at least 10 atom % significantly deteriorates the luminance. Therefore, the Mn activation amount is desirably at least 7 atom % to at most 9 atom %.

9-2. Mixing of ZSM Phosphor and YAG Phosphor

Focusing on the YAG phosphor which is a Ce³⁺-activated yttrium aluminum garnet phosphor having the afterglow time of at most 1 msec, the present inventors looked into luminescence characteristics and characteristics in the PDP of the YAG phosphor under the excitation by vacuum ultraviolet light. It was thereby learnt that the YAG phosphor had a luminance when used in the PDP which was much higher than expected from the results reported in literatures and evaluation results of phosphor powder alone, and further exerted quite a favorable stability in the lighting time of the PDP.

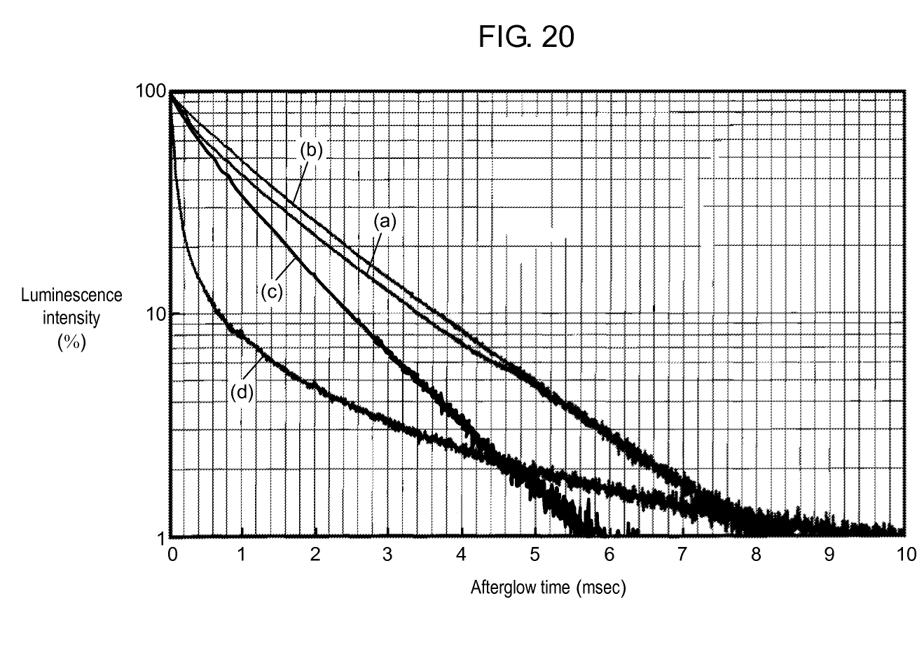

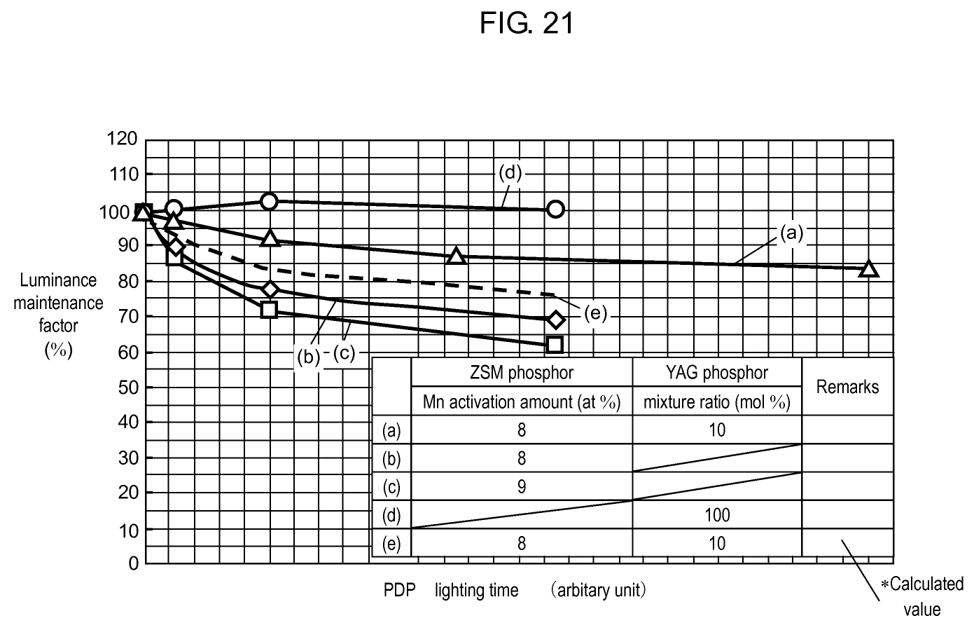

In FIGS. 20 and 21, (a) is a phosphor in which the YAG phosphor is mixed by 10 mol % (23 wt. %) with the ZSM phosphor having the Mn activation amount of 8 atom %, (b) is a phosphor in which the ZSM phosphor having the Mn activation amount of 8 atom % alone is used, (c) is a phosphor in which a ZSM phosphor having the Mn activation amount of 9 atom % alone is used, and (d) is a phosphor in which the YAG phosphor alone is used. Of these phosphors, (a) is the green phosphor of the PDP according to the present embodiment.

In these green phosphors, the afterglow time was 3.4 msec in (a), 3.7 msec in (b), 2.4 msec in (c), and 0.7 msec in (d) as illustrated in FIG. 20. These green phosphors succeeded in obtaining short persistence. Thus, these green phosphors all succeeded in reducing the afterglow time. The luminescence of the YAG phosphor (d) having the ultra-short persistent characteristics, in particular, stops as soon as the vacuum ultraviolet light, which is a source of excitation, is no longer generated.

As illustrated in FIG. 19, the conventional ZSM phosphor placing an emphasis on the luminance has the Mn activation amount below 6 atom %. As a result, the afterglow time thereof is at least 7 msec. In the green phosphor according to the present embodiment, the YAG phosphor is mixed by 10 mol % with the ZSM phosphor having the Mn activation amount of 8 atom %. The green phosphor according to the present embodiment accomplishes the afterglow time equal to or less than 3.5 msec, proving feasibility in a three-dimensional image display apparatus.

When the Mn activation amount in the ZSM phosphor is increased, or the YAG phosphor to be mixed is increased, the afterglow time can be further reduced to less than 3.0 msec.

As illustrated in FIG. 21, when the Mn activation amount in the ZSM phosphor alone is increased by 8% in (b), and 9% in (c), a luminance maintenance factor relative to the PDP lighting time deteriorates, which is a phenomenon often recognized in any short persistent ZSM phosphors in which the Mn²⁺ activation amount is increased. Therefore, it is not practically useful to shorten the afterglow time simply by increasing the Mn activation amount of the ZSM phosphor.

Though the luminance maintenance factor does not deteriorate in the YAG phosphor alone in (d), the luminescence of the YAG phosphor has a poor color purity as compared to the Mn²⁺-activated green phosphor. Therefore, it is difficult to use the YAG phosphor alone in green phosphor layer 32 of the PDP.

In (a), however, the luminance maintenance factor relative to the PDP lighting time is not as deteriorated as in (b) and (c) in which the Mn activation amount is simply increased.

Here, (e) is a calculated value when the YAG phosphor is mixed with the ZSM phosphor, which was calculated from the result of the phosphor powder alone.

The result of (a) showing the actually measured values in (a) indicates applicability to the PDP unlike the calculated values in (e).

A reason why the result of (a) is different to the result of (e) is; aged deterioration of the luminance results from Mn of the ZSM phosphor, however, the outermost layer of the ZSM phosphor is coated with the YAG phosphor more than expected from its mixture ratio when the YAG phosphor is mixed with the ZSM phosphor, meaning that deterioration of the ZSM phosphor caused by the ion-induced impact is thereby controlled.

Therefore, (a), though its afterglow time is short, can accomplish a high luminance over a long period of time.

In these phosphors, the luminance in an initial stage after the PDP was lighted was; 0.79 in (c), and 1.15 in (d) based on 1 of the phosphor in (b) having the afterglow time of 3.6 msec, but 1.06 in (a) according to the present embodiment. Thus, such a high luminance was achieved.

9-2-1. Mixture Ratio of YAG Phosphor

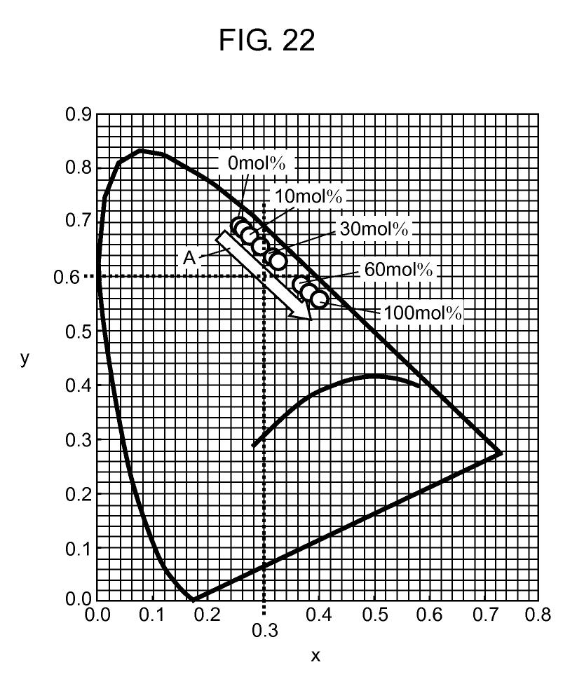

As illustrated in FIG. 22, x-y coordinates shift in the direction of arrow A as the mixture ratio of the YAG phosphor increases, meaning that the green light gradually changes its color tone to yellowish green. There are nine examples of the YAG phosphor mixture ratio; 0 mol %, 3 mol %, 10 mol %, 20 mol %, 30 mol %, 40 mol %, 60 mol %, 80 mol %, and 100 mol %. The color purity of green desirably has a value of x equal to or less than 0.3 and a value of y equal to or larger than 0.6. To have the value of y equal to or larger than 0.6, the YAG phosphor mixture ratio is desirably at most 40 mol %.

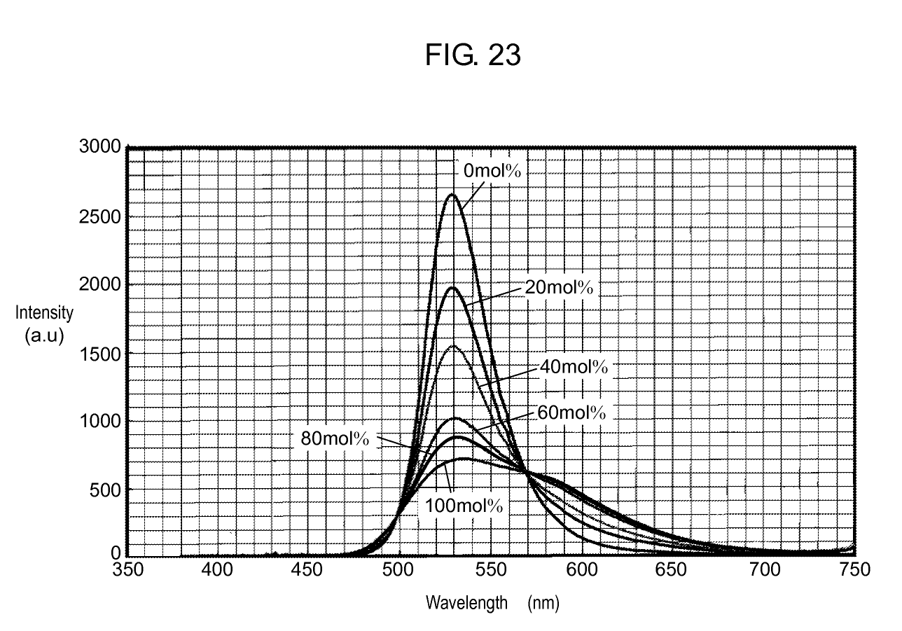

As illustrated in FIG. 23, the luminescence peak intensity of the short persistent ZSM phosphor around 530 nm declines as the YAG phosphor mixture ratio increases. The addition of the yellow-green light component of the YAG phosphor increases a half-value width of luminescence spectrum. The YAG phosphor alone has its luminescence peak in the wavelength region of at least 490 to less than 560 nm.

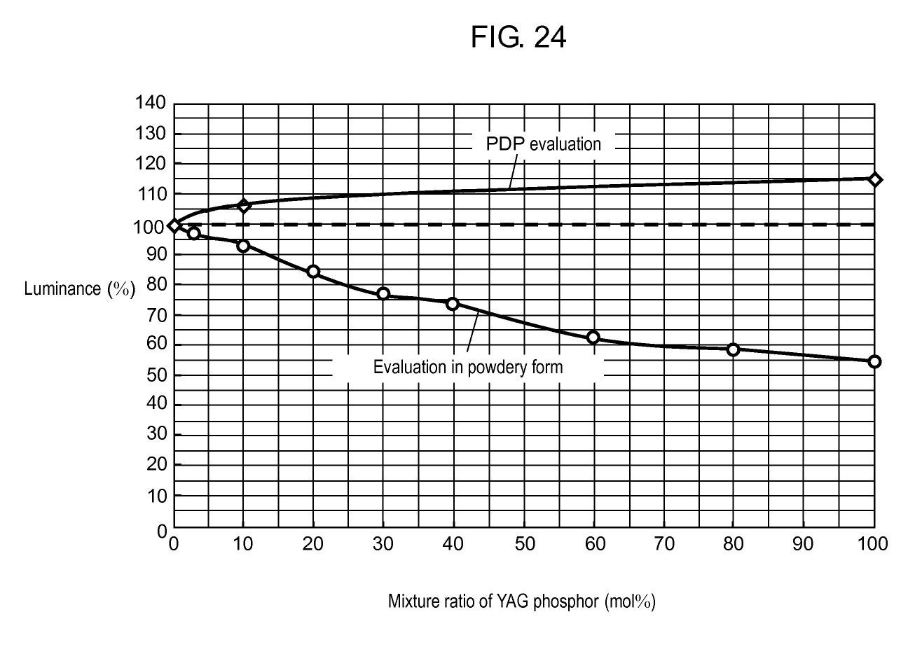

As illustrated in FIG. 24, the luminance of the green phosphor powder declines as the YAG phosphor mixture ratio increases. When the green phosphor is used in green phosphor layer 32 of the PDP, the luminance of the green phosphor powder improves as the YAG phosphor mixture ratio increase. Thus, the evaluation of the green phosphor when used as the green phosphor powder and the evaluation of the green phosphor when used in the PDP were contradictory to each other.

The evaluation in the powdery form is conventionally given under the condition that vacuum ultraviolet light is continuously applied. The evaluation when applied to the PDP is given under the condition that vacuum ultraviolet light is intermittently applied by using radio frequency pulses. Therefore, a phosphor having a shorter afterglow time can achieve a higher luminance, and an ultra-short persistent phosphor can achieve even a higher luminance. The evaluation in the powdery form is given under the excitation by vacuum ultraviolet light having the wavelength of 147 nm, in which an excimer light source is used. Thus, vacuum ultraviolet light having a single wavelength is irradiated. Meanwhile, the evaluation when applied to the PDP is given under the excitation by vacuum ultraviolet light through Ne—Xe electrical discharge, in which vacuum ultraviolet light having multiple wavelengths is applied. This raises the assumption that the YAG phosphor was probably excited by vacuum ultraviolet light having the wavelength other than 147 nm.

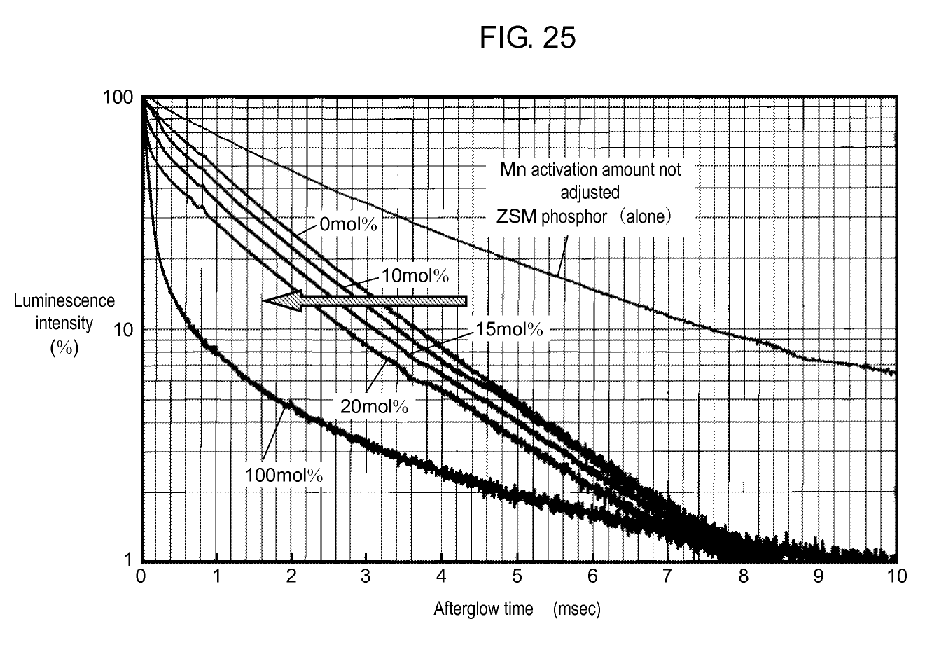

FIG. 25 illustrates afterglow characteristics in green pixels in which the afterglow time is shorter as the YAG phosphor mixture ratio increases. Examples of the YAG phosphor mixture ratio are; 0 mol %, 10 mol % (23 wt. %), 15 mol % (32 wt. %), 20 mol % (40 wt. %), and 100 mol %. As the YAG phosphor mixture ratio increases, the afterglow time is shorter as illustrated with an arrow in the figure, 3.6 msec, 3.4 msec, 3.1 msec, 2.7 msec, and then less than 1 msec.

FIG. 25 also illustrates afterglow characteristics of a conventional Mn²⁺-activated green phosphor as a comparative example. The conventional Mn²⁺-activated green phosphor is a phosphor in which the Mn activation amount is not adjusted, in other words, the Mn activation amount is not increased. The afterglow time of the comparative example is 7 msec to 8 msec. Therefore, the Mn²⁺-activated green phosphor is not applicable to the PDP which displays a three-dimensional image.

Table 1 shows the conventional example disclosed in Unexamined Japanese Patent Publication No. 2009-185276. Table 2 shows a result of the green phosphor according to the present embodiment.

### [Table 1]

In Table 1, “A”, “B”, “C”, and “D” are used to show an evaluation result. “A” represents “level which fully meets applicability requirements”, “B” represents “level which meets applicability requirements”, “C” represents “level for which applicability can be discussed”, and “D” represents “level which fails to meet applicability requirements”. With “D” in at least one of the evaluation items, an overall evaluation results in “D”. The evaluation method described so far is also applied to Tables 2 and 3 described later. Any bracketed evaluation values such as (A) are values estimated from actually measured values.

Table 1 shows a result of a green phosphor in which the YAG phosphor is mixed with a ZSM phosphor having the Mn activation amount equal to or less than 3.0 atom %. The evaluation items are; green color tone, afterglow time, and the PDP luminance with different mixture ratios of the YAG phosphor. The color tone was evaluated based on whether the y value of color coordinates was at least 0.6. The afterglow time was evaluated based on whether or not exceeding 3.5 msec. The luminance was evaluated based on relative values to the evaluation result of the ZSM phosphor alone.

TABLE 1

| | YAG phosphor mixture ratio (mol %) | | | | | |
|---|---|---|---|---|---|---|
| | 0 | 27 | 36 | 47 | 60 | 100 |
| Green color tone | A | C | C | D | D | D |
| (y > 0.6) | | | | | | |
| Afterglow time | D | D | D | A | A | A |
| (<3.5 msec) | | | | | | |
| PDP luminance | A | B | B | B | B | B |
| Overall | D | D | D | D | D | D |
| evaluation | | | | | | |

As is known from Table 1, there is no range where the color tone and the afterglow time can be both met when the YAG phosphor is mixed with the conventional ZSM phosphor.

### [Table 2]

Table 2 shows a result of a green phosphor in which the YAG phosphor is mixed with a short persistent ZSM phosphor having the Mn activation value of 8.0 atom %. The evaluation items further include lifetime (luminance maintenance factor) to the items shown in Table 1.

As is known from Table 2, the YAG phosphor mixture ratio when the YAG phosphor is mixed with the short persistent ZSM phosphor is preferably at least 3 mol % to at most 40 mol %. The YAG phosphor mixture ratio is more preferably at least 8 mol % to at most 15 mol %. In these ranges, overall characteristics in terms of the luminance, color tone, afterglow time, and lifetime (luminance maintenance factor) are met.

When the YAG phosphor mixture ratio exceeds 40 mol %, the green color tone is disturbed. When the YAG phosphor mixture ratio is less than 3 mol %, the afterglow time, luminance, and lifetime are not good enough to meet the expectation.

9-2-2. Particle Diameters of Phosphor

The green phosphor according to the present embodiment is preferably an assembly of particles having primary particle diameters of 0.5 μm to 2 μm. An average particle diameter of the phosphor particles (D50) is preferably at least 1.5 μm to less than 4.0 μm, and more preferably at least 1.8 μm to less than 3.5 μm. Further, it is preferable to adjust the primary particle diameters and average particle diameter so that the YAG phosphor with the ZSM phosphor are mixed well.

TABLE 2

| | YAG phosphor mixture ratio (mol %) | | | | | | | | | | | |
|---|---|---|---|---|---|---|---|---|---|---|---|---|
| | 0 | 3 | 8 | 10 | 15 | 20 | 30 | 40 | 50 | 60 | 80 | 100 |
| Green color | A | A | (A) | A | (A~B) | B | C | C | (D) | D | D | D |
| tone (y > 0.6) | | | | | | | | | | | | |
| Afterglow time | C | B | (B) | B | B | A | | (A) | | | | A |
| (<3.5 msec) | | | | | | | | | | | | |
| PDP luminance | C | (B) | (B) | (B) | B | B | | (B) | | | | C |
| Life time | D | (C) | (B) | B | (B) | | | (B) | | | | A |
| Overall | D | B | A | A | A | B | B | B | D | D | D | D |
| evaluation | | | | | | | | | | | | |

When the primary particle diameters and average particle diameter are set in the foregoing ranges, the surface of green phosphor layer 32 can be smoothened and the discharge space can be enlarged in the PDP. Then, green phosphor layer 32 can increase its electric discharge efficiency, and the barrier ribs are better coated with the phosphor particles, so that the luminance is improved. Further, green phosphor layer 32 increases its density, thereby preventing the generation of an impurity gas. As a result, the electric discharge can be more stabilized.

9-2-3. Another Embodiment

Examples of the short persistent ZSM phosphor in which the Mn activation amount is adjusted are; a phosphor in which a base material is improved, more specifically, a ZSM phosphor in which a surface of the base material is coated with MgO or SiO₂, and a ZSM phosphor in which the composition ratio of Zn or Si is slightly shifted from stoichiometry (Zn, Mn)₂SiO₄ so that a half value of number of atoms in total in (Zn⁺ Mn) for one Si atom exceeds 0.5 and stays below 2.0. For example, (Zn,Mg)₂SiO₄:Mn²⁺, Zn₂(Si,Ge)O₄;Mn²⁺, and an impurity-containing ZSM phosphor may be used.

A ZSM phosphor surface-coated with a phosphorous compound may also be used. The surface-coated short persistent ZSM phosphor can control the ion-induced impact, thereby improving its own stability.

The YAG phosphor according to the present embodiment is a phosphor activated by Ce³⁺ and including at least yttrium, aluminum, and oxygen as chief ingredients of a basic skeleton constituting phosphor crystals.

The present embodiment suggested the green phosphor in which the short persistent ZSM phosphor in which the Mn activation amount is adjusted is mixed with the YAG phosphor as the Ce³⁺-activated green phosphor. However, Ca₂MgSi₂O₇:Eu²⁺ which is an Eu²⁺-activated green phosphor, for example, may be used in place of the YAG phosphor. Ce³⁺ and Eu²⁺ functioning as a luminescence center are more stable than Mn²⁺ because it is easier to change the valence of ions. Therefore, a similar operational effect can be expected on one level or another as far as at least one of a Ce³⁺-activated green phosphor other than the Ce³⁺-activated YAG phosphor and an Eu²⁺-activated green phosphor is mixed.

Y₃(Al,Ga)₅O₁₂:Ce³⁺, and MgY₂SiAl₄O₁₂:Ce³⁺ are also examples of the Ce³⁺-activated YAG phosphor.

Usable examples other than the Ce³⁺-activated YAG phosphor are; Eu²⁺-activated oxonitridosilicate green phosphor (for example, Ba₃Si₆O₁₂N₂:Eu²⁺ (generally called BSON)), Eu²⁺-activated oxonitridoaluminosilicate green phosphor (for example, SiSiAl₂O₃N₂:Eu²⁺), Eu²⁺-activated alkaline earth metal halosilicate green phosphor (for example, Sr₄Si₃O₈C₁₄:Eu²⁺ (generally called chlorosilicate), Ca₈Mg(SiO₄)₄Cl₂:Eu²⁺, Ca₃SiO₄Cl₂:Eu²⁺), Eu²⁺-activated alkaline earth metal silicate green phosphor (for example, Ba₂MgSi₂O₇:Eu²⁺, Ca₂MgSi₂O₇:Eu²⁺, or BaSi₂O₅:Eu²⁺), Eu²⁺-activated alkaline earth metal boron phosphate green phosphor (for example, Sr₆BP₅O₂₀:Eu²⁺), and Eu²⁺-activated alkaline earth metal aluminate green phosphor (for example, Ba_{0.82}Al₁₂O_{18.82}:Eu²⁺).

10. Red Phosphor

A red phosphor constituting red phosphor layer 31 according to the present embodiment has a main luminescence peak in the wavelength region of at least 610 nm to less than 630 nm (hereinafter, called first wavelength region). The red phosphor further has an orange luminescence peak in the wavelength region of at least 580 nm to less than 600 nm (hereinafter, called second wavelength region).

The red phosphor according to the present embodiment is an Eu³⁺-activated red phosphor in which a luminescence peak intensity in the second wavelength region is at least 5% to less than 20% of a main luminescence peak intensity in the first wavelength region. The “red phosphor having a main luminescence peak in the first wavelength region and activated by Eu³⁺” denotes a red phosphor including Eu³⁺ as an activator in which a luminescent component having the largest luminescence intensity among luminescent components emitted by Eu³⁺ is in the first wavelength region. Therefore, the red phosphor does not include, for example, orange/red-orange phosphors having a main luminescence peak near 593 nm such as InBO₃:Eu³⁺ and YGB phosphor known as phosphors for electronic tubes.

The Eu³⁺-activated phosphor having a main luminescence peak in the first wavelength region has a large proportion of luminescent components based on the electron dipole transition of Eu³⁺ ions unlike the YGB phosphor having a main luminescence peak near 590 nm. Therefore, the afterglow time is relatively short, about 2 msec to 5 msec.

In red light emitted from the red phosphor, a luminescence peak intensity thereof in the second wavelength region is preferably below 20%, more preferably below 15%, and even more preferably below 13% of a main luminescence peak thereof in the first wavelength region, so that a red color purity can be maintained.

The red light emitted from the red phosphor described so far generally has a small proportion of luminescent components based on the magnetism dipole transition of Eu³⁺ ions on the whole, but has a large proportion of luminescent components based on the electron dipole transition of Eu³⁺ ions. The afterglow time of the luminescence based on the electron dipole transition is about 2 msec to 5 msec. The afterglow time of the luminescence based on the magnetism dipole transition is at least about 10 msec. Therefore, the red phosphor described earlier is preferably used to obtain red light having short persistent characteristics of at most about 3 msec.

Examples of the red phosphor include YOX phosphor (Y, Gd)₂O₃:Eu³⁺ (hereinafter, called YGX phosphor), and YPV phosphor.

The red phosphor in the PDP according to the present embodiment is at least a phosphor selected from Ln₂O₃:Eu³⁺, and Ln(P,V)O₄:Eu³⁺, in which Ln is preferably at least an element selected from Sc, Y, and Gd.

Though the red light may be red light before passing through an optical filter separately provided on the front face of the PDP, the red light is preferably red light having passed through an optical filter optically designed to overly absorb at least orange light components near the wavelength region of 590 nm to 595 nm. When the red phosphor is combined with the optical filter, the orange light emitted from Ne discharge can be reduced. Further, an output ratio of the orange light components near 593 nm having a long afterglow time, which is emitted from the Eu³⁺-activated red phosphor, can be reduced. As a result, a color image can have better contrast and red color tone. Further, the afterglow time can still be reduced when a red phosphor having a large proportion of long persistent orange light components is used.

The YPV phosphor can release a larger number of photons under the excitation by vacuum ultraviolet light as more phosphorous is included and more long persistent orange light components are included. In other words, a phosphor can achieve a higher photon conversion efficiency as more phosphorous is included. Therefore, when a long persistent YPV phosphor having a high photon conversion efficiency is used in combination with an optical filter, a predetermined short persistent red light can be obtained.

10-1. Evaluation of Red Phosphor

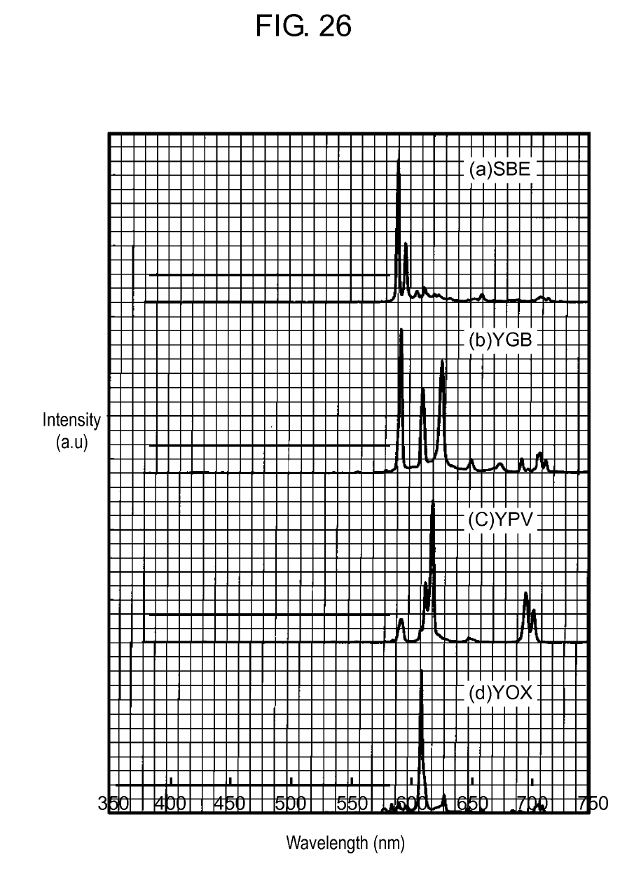

As illustrated in FIG. 26, different red phosphors respectively have different luminescence spectrums. Examples of the Eu³⁺-activated red phosphor are; (a) ScBO₃;Eu³⁺ (SBE phosphor), (b) YGB phosphor, (c) YPV phosphor, and (d) YOX phosphor. These phosphors were all evaluated in the form of phosphor powder.

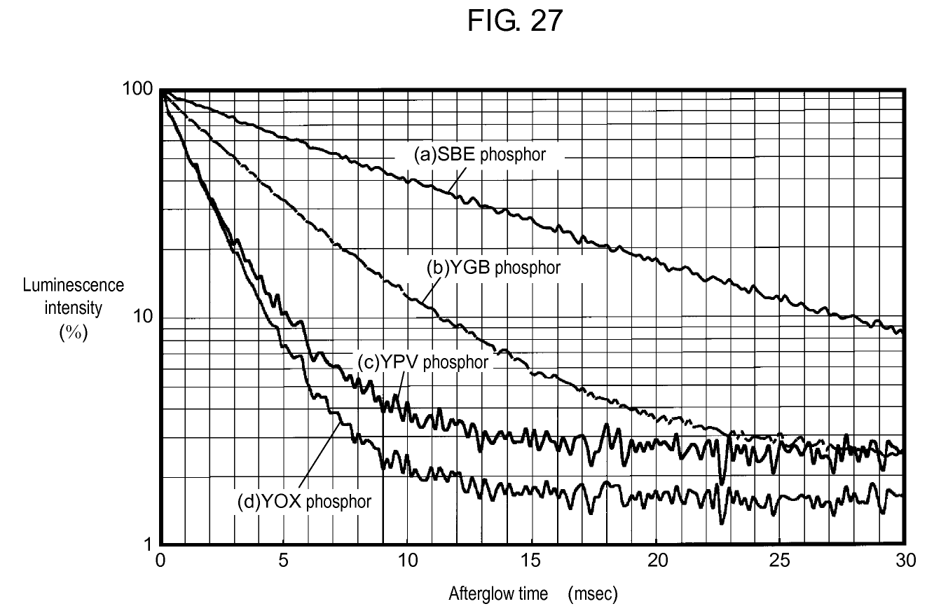

As illustrated in FIG. 27, the afterglow time is shorter in the order of (a), (b), (c), and (d).

As illustrated in FIGS. 26 and 27, the afterglow time of the Eu³⁺-activated red phosphor is correlated to a ratio of intensities between red luminescent components emitted based on the electron dipole transition in the first wavelength region and orange luminescent components emitted based on the magnetism dipole transition in the second wavelength region. As a phosphor includes more red luminescent components in the first wavelength region, its afterglow time is shorter.

The red phosphor used in the present embodiment is the YPV phosphor which is the Eu³⁺-activated red phosphor in which a large proportion of luminescence is based on the electron dipole transition of Eu³⁺ ions. As a result, the afterglow time of the red luminescence was shortened. The YPV phosphor includes a smaller proportion of orange luminescent components based on the magnetism dipole transition and a larger proportion of red luminescent components based on electron dipole transition as a proportion of P (hereinafter, called P proportion) in the total volume of P and V in the YPV phosphor. Therefore, as the used YPV phosphor has a smaller P proportion, the afterglow time is even shorter.

10-1-1. Evaluation of YPV Phosphor

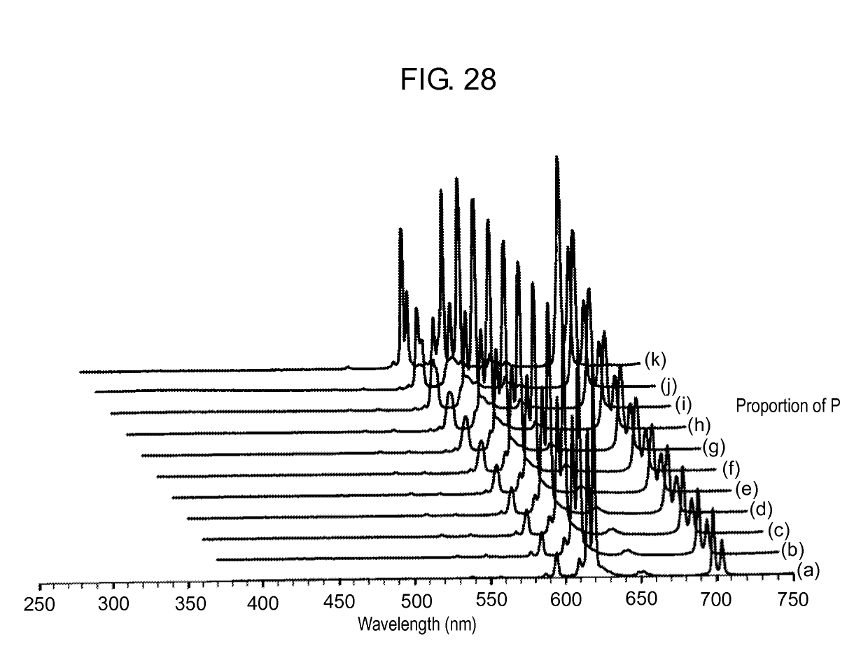

As illustrated in FIG. 28, the main luminescence peak intensity in the first wavelength region and the luminescence peak intensity in the second wavelength region change as the P proportion changes. The P proportions illustrated in FIG. 28; 0% in (a), 10% in (b), 20% in (c), 30% in (d), 40% in (e), 50% in (f), 60% in (g), 70% in (h), 80% in (i), 90% in (j), and 100% in (k). All of the percentages are atom %.

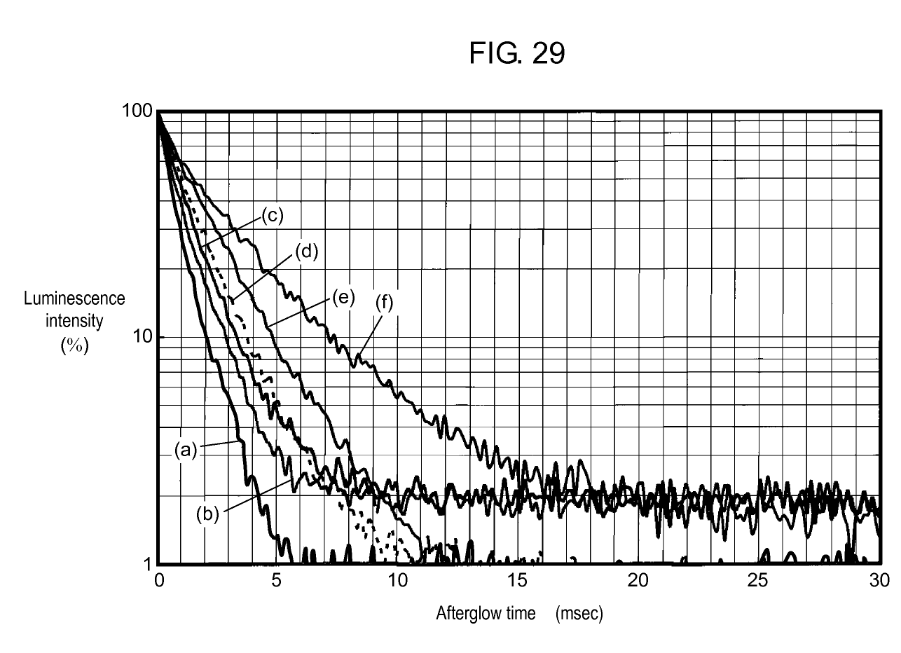

As illustrated in FIG. 29, the afterglow time changes as the P proportion changes. The P proportions illustrated in FIG. 29 are; 0% in (a), 20% in (b), 40% in (c), 60% in (d), 80% in (e), and 100% in (f). All of the percentages are atom %. Thus, the afterglow time is shorter as the P proportion is smaller.

The results illustrated in FIGS. 28 to 32 are obtained from the evaluation of the YPV phosphor powder.

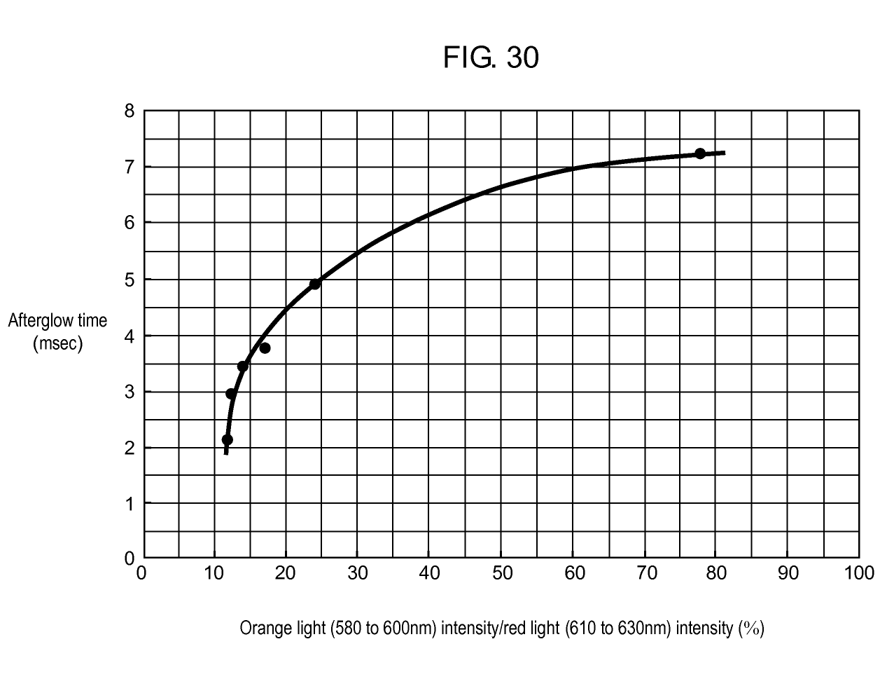

As illustrated in FIG. 30, the afterglow time is correlated to a ratio of intensity of the main luminescence peak in the first wavelength region to the luminescence peak in the second wavelength region. It is illustrated in the drawing that the afterglow time shows a sharp drop as the ratio of intensity is smaller. When the ratio of intensity stays in the range of at least 10% to below 20%, the afterglow time is at least 2.0 msec to below 4.5 msec. When the ratio of intensity stays in the range of at least 10% to below 15%, the afterglow time is at least 2.0 msec to at most 3.5 msec. When the ratio of intensity stays in the range of at least 10% to below 12%, the afterglow time is at least 2.0 msec to at most 3.0 msec. Therefore, the ratio of intensity preferably stays in the range of at least 5% to below 15%, and more preferably stays in the range of at least 5% to below 12% so that the afterglow time of the red phosphor stays below 3.5 msec after test errors are taken into account.

The present inventors learnt from an evaluation result when the YPV phosphor powders having different P proportions are applied to the PDP that the P proportion to obtain the red light afterglow time below 3.5 msec is at least O atom % to below 75 atom %. To further reduce the afterglow time to less than 3.0 msec, the P proportion is preferably at last O atom % to below 70 atom %.

Red phosphor layer 31 in the PDP according to the present embodiment includes the red phosphor containing one of the YPV phosphor and (Y,Gd)(P,V)O₄:Eu³⁺ (hereinafter, called YGPV phosphor), and the P proportion is at least O atom % to below 75 atom %.

The afterglow time of the red phosphor according to the present embodiment is at most 3.5 msec.

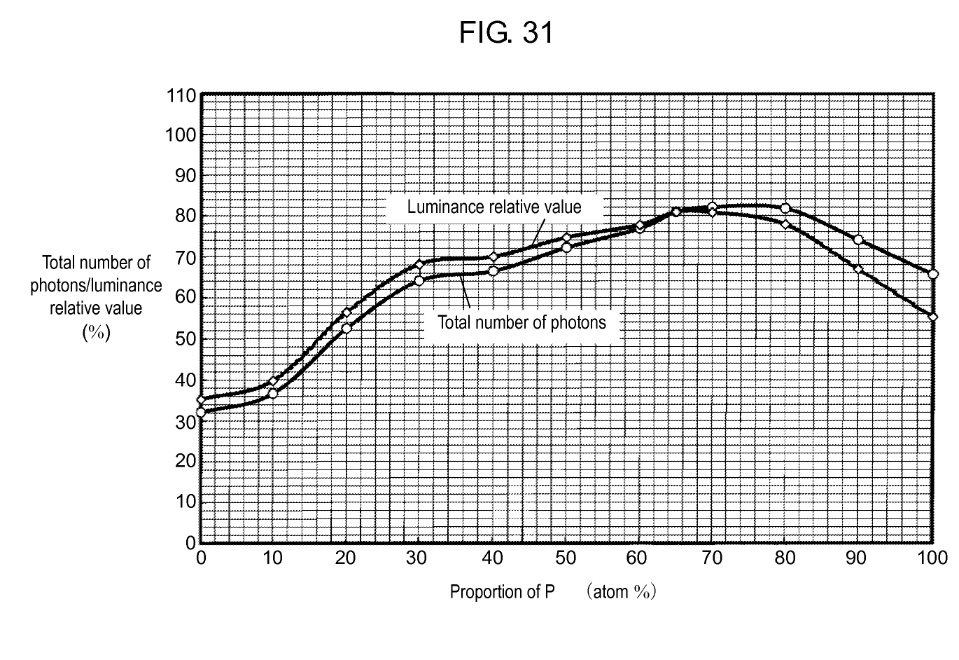

As illustrated in FIG. 31, a total number of photons and a luminance relative value in the YPV phosphor depend on the P proportion. The total number of photons and the luminance relative value were evaluated by exciting the YPV phosphor by vacuum ultraviolet light having the wavelength of 147 nm. The total number of photons increases as the P proportion increases from 0%, however, has a peak when the P proportion hits around 70%. Then, the total number of photons decreases as the P proportion further increases. The total number of photons when the P proportion is 100% is equal to the total number of photons when the P proportion is 20%. A large number of photons in total indicate a high optical conversion efficiency.

Table 3 shows the red color tone, afterglow time, and the PDP luminance for the respective P proportions in the YPV phosphor based on the evaluation result described earlier.

### [Table 3]

It is known from Table 3 that the YPV phosphor has a longer afterglow time as the P proportion is higher. However, the red light can have a shorter afterglow time when an optical filter optically designed to overly absorb the orange color components is used. When a phosphor whose afterglow time exceeds 3.0 msec according to the evaluation of red phosphor powder is used in the PDP, the afterglow time can be reduced to at most 3.0 msec.

As shown in Table 3, the P proportion of the YPV phosphor having a large total number of red light photons stays in the range of at least 50 atom % to at most 90 atom %, preferably stays in the range of at least 60 atom % to at most 90 atom %, and more preferably stays in the range of at least 60 atom % to at most 80 atom %.

To keep a good balance between the afterglow time and the total number of photons, it is preferable to use a YPV phosphor having the P proportion in the range of at least 50 atom % to at most 80 atom %.

TABLE 3

| | Proportion of P (atom %) | | | | | | | | | | |
|---|---|---|---|---|---|---|---|---|---|---|---|
| | 0 | 10 | 20 | 30 | 40 | 50 | 60 | 70 | 80 | 90 | 100 |
| Red color | A | A | A | A | A | B | B | B | B | B2 | D |
| tone | | | | | | | | | | | |
| Afterglow | A | | A | | B | | B | | C | | D |
| time | | | | | | | | | | | |
| (<3.5 msec) | | | | | | | | | | | |
| PDP | D | A | D | C | C | B | A | A | A | C | C |
| luminance | | | | | | | | | | | |
| Total number | D | A | D | D | C | B | A | A | A | B | |
| of photons | | | | | | | | | | | |
| Overall | D | D | D | D | C | B | A | A | B | D | D |
| evaluation | | | | | | | | | | | |

10-1-2. Still Another Embodiment

When it is desirable to have a deep red color tone in the PDP, the YPV phosphor may be singly used as the red phosphor. When it is desirable to have a red luminance, a YOX phosphor or a YGX phosphor which emits red light having a good visibility may be used as the red phosphor.

When it is desirable to place an emphasis on the red color tone and seek a high luminance, a mixed red phosphor obtained by mixing at least one of the YOX phosphor and YGX phosphor with the YPV phosphor is preferably used. Such a mixed red phosphor improves red light visibility.

11. Blue Phosphor

A blue phosphor constituting blue phosphor layer 33 according to the present embodiment is an Eu²⁺-activated blue phosphor having a main luminescence peak in the wavelength region of at least 420 nm to below 500 nm. Such a blue phosphor having Eu² as an activator becomes luminescent based on the 4f⁶5d¹→4f⁷ electron energy transition of Eu²⁺ ions. Therefore, blue luminescence whose afterglow time is below 1 msec can be accomplished.

Specific examples of the blue phosphor are; BAM phosphor, CaMgSi₂O₆:Eu²⁺ (CMS phosphor), and Sr₃MgSi₂O₈:Eu²⁺ (SMS phosphor).

12. Summary of Phosphor Layers

As described so far, the PDP according to the present embodiment has the following phosphors. The red phosphor is the Eu³⁺-activated red phosphor which emits red light having a main luminescence peak in the first wavelength region, wherein the luminescence peak intensity in the second wavelength region is at least 5% to below 20% of the main luminescence peak.

The green phosphor is the mixed phosphor obtained by mixing the Mn²⁺-activated short persistent green phosphor which emits green light having a luminescence peak in the wavelength region of at least 500 nm to below 560 nm and having the afterglow time exceeding 2 msec and staying below 5 msec with the Ce³⁺-activated phosphor having a luminescence peak in the wavelength region of at least 490 nm to below 560 nm.

The blue phosphor is the Eu2+-activated blue phosphor having a main luminescence peak in the wavelength region of at least 420 nm to below 500 nm.

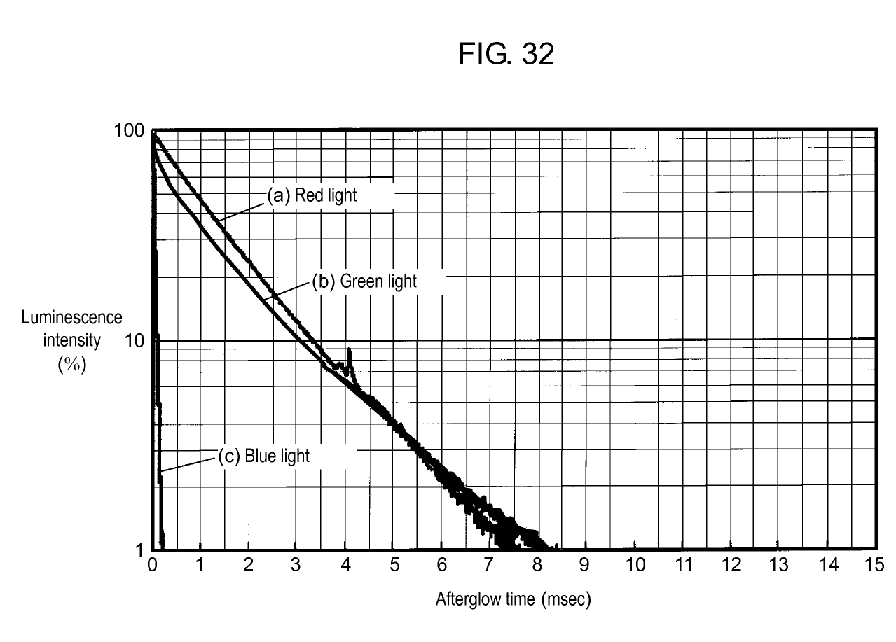

As illustrated in FIG. 32, the afterglow time when the phosphor is applied to the PDP is; 3.3 msec in red light (a), 3.0 msec in green light (b), and at most 1 msec in blue light (c). The red phosphor constituting red phosphor layer 31 used then was, for example, a YPV phosphor in which the P proportion of the YPV phosphor was 40 atom %. The green phosphor constituting green phosphor layer 32 used then was, for example, the mixed phosphor in which the YAG phosphor was mixed by 15 mol % with the ZSM phosphor having the Mn activation amount of 8 atom %. The blue phosphor constituting blue phosphor layer 33 used then was, for example, the BAM phosphor.

When the PDP according to the present embodiment is used as a three-dimensional image display apparatus and a liquid crystal shutter is opened and closed at 120 Hz, crosstalk, which is double vision of an image, is prevented from happening. Therefore, a three-dimensional image thus displayed causes less eye strain.

Because red light is generally inferior to green light in view of visibility, the afterglow of red light appears to be darker than that of green light. Therefore, as illustrated in FIG. 32, the afterglow time of red light is preferably longer than that of green light, in which case the luminance of red light can be relatively higher than the luminance levels of green and blue light. Therefore, the PDP can achieve a higher luminance while avoiding crosstalk.

In place of the YAG phosphor mixed with the ZSM phosphor, Ce³⁺-activated green phosphor, Eu²⁺-activated green phosphor, or Tb³⁺-activated green phosphor other than the YAG phosphor may be used. When any of these phosphors is used, a similar operational effect can be expected because of their similar physical properties. The Eu²⁺-activated green phosphor, in particular, generates green light having a good color purity because of its half-value width of luminescence spectrum narrower than that of the Ce³⁺-activated green phosphor, thereby improving the green color tone. When a Tb³⁺-activated green phosphor, such as a YAB phosphor having a luminescence peak near 545 nm with a better visibility, is included, a high luminance can be accomplished.

The afterglow times of green and red light illustrated in FIG. 32 can be reduced to at most 3.0 msec when the materials are designed.

13. Summary

First PDP 1 according to the present embodiment has front plate 2 and rear plate 10 disposed so as to face front plate 2. Front plate 2 includes display electrodes 6, dielectric layer 8 covering display electrodes 6, and protective layer 9 formed to coat dielectric layer 8. Protective layer 9 includes base film 91 which is a base layer formed on dielectric layer 8, and a plurality of aggregated particles 92 dispersed on an entire surface of base film 91. Aggregated particle 92 includes a plurality of crystal particles 92a made of a metallic oxide and aggregating to one another. Rear plate 10 has phosphor layers 15 excited by ultraviolet light. Phosphor layers 15 include green phosphor layer 32 containing an Mn²⁺-activated short persistent green phosphor whose 1/10 afterglow time exceeds 2 msec and stays below 5 msec, and a Ce³⁺-activated green phosphor or an Eu²⁺-activated green phosphor having a luminescence peak in a wavelength region of at least 490 nm to less than 560 nm.

Second PDP 1 according to the present embodiment has front plate 2 and rear plate 10 disposed so as to face front plate 2. Front plate 2 includes display electrodes 6, dielectric layer 8 covering display electrodes 6, and protective layer 9 formed to coat dielectric layer 8. Protective layer 9 includes base film 91 formed on dielectric layer 8, a plurality of first particles dispersed on an entire surface of base film 91, and a plurality of second particles dispersed on the entire surface of the base film. The first particle is aggregated particle 92 including a plurality of crystal particles 92a made of a metallic oxide and aggregating to one another, and the second particle is crystal particle 93 made of magnesium oxide and having a cubic shape. Rear plate 10 has phosphor layers 15 excited by ultraviolet light. Phosphor layers 15 include green phosphor layer 32 containing an Mn²⁺-activated short persistent green phosphor whose 1/10 afterglow time exceeds 2 msec and stays below 5 msec, and a Ce³⁺-activated green phosphor or an Eu²⁺-activated green phosphor having a luminescence peak in a wavelength region of at least 490 nm to less than 560 nm.

PDP 1 according to the present embodiment exerts a high primary electron releasability and a high charge retainability. PDP 1 is further advantageous in; avoiding an electric discharge delay generated in such a high-speed drive having a short address period that right-eye and left-eye fields are alternately displayed repeatedly, preventing flickering images due to any address error, and controlling crosstalk generated between right-eye and left-eye images because of a short afterglow time.

In the description given so far, MgO is used as base film 91. The overriding performance demanded in base film 91 is a high sputtering resistance in order to protect the dielectric member from any impact from ions. In conventional PDPs, a protective layer containing MgO as its principal ingredient was often formed to meet two requirements, an expected level of electron releasability and sputtering resistance. The present embodiment is technically characterized in that the electron releasability is mostly controlled by aggregated particles 92. Therefore, MgO is not an indispensable material, and other materials superior in shock resistance, such as Al₂O₃, may be used.

In the description of the present embodiment, MgO particles were used as monocyrstal particles. The monocrystal particles are not necessarily limited to the MgO particles because a similar effect can be obtained from crystal particles made of any of metallic oxides as Sr, Ca, Ba, and Al which all have a high electron releasability similarly to MgO.

### INDUSTRIAL APPLICABILITY

The technology disclosed in the embodiment of the present invention enables a display performance with a higher definition and a higher luminance and reduction of power consumption in the PDP.

### REFERENCE MARKS IN THE DRAWINGS

1 PDP
2 front plate
3 front glass substrate
4 scan electrode
4a, 5a transparent electrode
4b, 5b metal bus electrode
5 sustain electrode
6 display electrode
7 black stripe
8 dielectric layer
9 protective layer
10 rear plate
11 rear glass substrate
12 data electrode
13 insulating layer
14 barrier rib
15 phosphor layer
16 discharge space
21 image signal processing circuit
22 data electrode drive circuit
23 scan electrode drive circuit
24 sustain electrode drive circuit
25 timing generation circuit
31 red phosphor layer
32 green phosphor layer
33 blue phosphor layer
91 base film
92 aggregated particle
92a, 92b, 93 crystal particle
100 plasma display device

1. A plasma display panel, comprising:
a front plate; and
a rear plate disposed so as to face the front plate, wherein
the front plate includes display electrodes, a dielectric layer covering the display electrodes, and a protective layer formed to coat the dielectric layer,
the protective layer includes a base layer formed on the dielectric layer and a plurality of aggregated particles dispersed on an entire surface of the base layer,
each of the aggregated particle includes a plurality of crystal particles made of metallic oxide and aggregating to one another,
the rear plate has phosphor layers excited by ultraviolet light, and
the phosphor layers include a green phosphor layer containing an Mn²⁺ activated short persistent green phosphor whose 1/10 afterglow time exceeds 2 msec and stays below 5 msec, and a Ce³⁺ activated green phosphor or an Eu²⁺ activated green phosphor having a luminescence peak in a wavelength region of at least 490 nm to less than 560 nm.

2. A plasma display panel, comprising:
a front plate; and
a rear plate disposed so as to face the front plate, wherein
the front plate includes display electrodes, a dielectric layer covering the display electrodes, and a protective layer formed to coat the dielectric layer,
the protective layer includes a base layer formed on the dielectric layer, a plurality of first particles dispersed on an entire surface of the base layer, and a plurality of second particles dispersed on the entire surface of the base layer,
each of the first particle includes a plurality of crystal particles made of metallic oxide and aggregating to one another,
each of the second particles is a crystal particle having a cubic shape, the rear plate has phosphor layers excited by ultraviolet light, and
the phosphor layers include a green phosphor layer containing an Mn²⁺ activated short persistent green phosphor whose 1/10 afterglow time exceeds 2 msec and stays below 5 msec, and a Ce³⁺ activated green phosphor or an Eu²⁺ activated green phosphor having a luminescence peak in a wavelength region of at least 490 nm to less than 560 nm.

3. The plasma display panel according to claim 1, wherein
an average particle diameter of the aggregated particles is at least 0.9 μm to at most 2 μm.

4. The plasma display panel according to claim 1, wherein
the crystal particles made of the metallic oxide have a polyhedral shape having at least seven surfaces.

5. The plasma display panel according to claim 1, wherein
the base layer includes magnesium oxide.

6. The plasma display panel according to claim 1, wherein
the Mn²⁺ activated short persistent green phosphor is an Mn²⁺ activated zinc silicate green phosphor, and
zinc atoms in the Mn²⁺ activated zinc silicate green phosphor by at least 6.5 atom % to less than 10 atom % are manganese-substituted.

7. The plasma display panel according to claim 1, wherein
the green phosphor includes the Ce³⁺ activated green phosphor by at least 3 mol % to at most 40 mol %, and
the Ce³⁺ activated green phosphor is a Ce³⁺ activated yttrium aluminum garnet phosphor.

8. The plasma display panel according to claim 2, wherein
an average particle diameter of the aggregated particles is at least 0.9 μm to at most 2 μm.

9. The plasma display panel according to claim 2, wherein
the crystal particles made of the metallic oxide have a polyhedral shape having at least seven surfaces.

10. The plasma display panel according to claim 2, wherein
the base layer includes magnesium oxide.

11. The plasma display panel according to claim 2, wherein
the Mn²⁺ activated short persistent green phosphor is an Mn²⁺ activated zinc silicate green phosphor, and
zinc atoms in the Mn²⁺ activated zinc silicate green phosphor by at least 6.5 atom % to less than 10 atom % are manganese-substituted.

12. The plasma display panel according to claim 2, wherein
the green phosphor includes the Ce³⁺ activated green phosphor by at least 3 mol % to at most 40 mol %, and
the Ce³⁺ activated green phosphor is a Ce³⁺ activated yttrium aluminum garnet phosphor.
